(19) United States
(12) Patent Application Publication
(10) Pub. No.: US 2008/0221861 A1
(43) Pub. Date: Sep. 11, 2008

(54) Verification Apparatus and Verification Method

(76) Inventors: Kei Yoneda, Hyogo (JP); Yoichiro Mae, Osaka (JP); Hisato Yoshida, Nara (JP)

Correspondence Address: MCDERMOTT WILL & EMERY LLP, 600 13TH STREET, NW, WASHINGTON, DC, 20005-3096, US

(21) Appl. No.: 10/586,620

(22) PCT Filed: Jan. 18, 2005
(86) PCT No.: PCT/JP05/00528

§ 371 Date: Jul. 19, 2006

(30) Foreign Application Priority Data
Jan. 20, 2004 (JP) 2004-012383

(51) Int. Cl. G06F 9/455

(52) U.S. Cl. 703/26

(57) ABSTRACT

When performing a process in an object to be authenticated, there is a case that an execution result depends on the reference data value to be referenced and remains undefined. When the execution result is undefined and a process after that references the execution result, the execution results may have different values. As a result, the execution results cannot be compared and authentication cannot be continued. There is provided an authentication device for giving the same test pattern to an object to be authenticated and an expectation value generation device, performing simulation, and comparing the execution results. Data being simulated is extracted. According to the analysis result of the extracted data, the simulation is controlled. Alternatively, simulation after the undefined result is obtained is controlled. Thus, it is possible to prevent execution of a process which becomes an undefined result.

### BACKGROUND OF THE INVENTION

1. Field of the Invention

The present invention relates to verification of a semiconductor integrated circuit on a computing device.

2. Description of the Related Art

As a method of verifying a semiconductor integrated circuit is available a verification method in which a circuit data described in a model description language, such as a hardware description language, is simulated on a computing device so that whether or not the circuit data is normally operated is confirmed, on a computer. In the verification method, it is necessary to input a test pattern in order to operate the circuit data, and to prepare an expectation value of an execution result in order to confirm the operation. The expectation value to be prepared may be prepared in advance, or can employ an execution result obtained in such a manner that a pseudo model of the circuit data is prepared, and a test pattern, which is identical to a test pattern applied to a true circuit data, is also supplied to the pseudo model.

As a conventional technology in the verification method, there is available a method in which a test pattern which generates an error is registered in the case where the error is generated when test patterns are sequentially executed in order to delete the test pattern which generates the error in the simulation thereafter so that the verification can be thereby more efficient (see the Patent Literature 1)
Patent Document 1: No. 3054802 of the Japanese Patent Publication

### DISCLOSURE OF THE INVENTION

### Problems to be Solved by the Invention

In a conventional verification method such as a verification method for a processor, there is a possibility that zero division (division in which a divisor is zero) is executed when a division instruction is executed. Therefore, special considerations are necessary so that zero is not used as the divisor when the division instruction is generated, particularly in a verification environment where test patterns randomly generated are applied to a verification object.

In the case of executing the zero division in the conventional verification method, an execution result of the division may not be guaranteed (non-guaranteed result) depending on a specification of the processor. Describing the non-guaranteed result, a computation result (quotient and remainder) obtained from a correct division fails to be stored as the result of the execution of the division instruction. In the present invention, such an execution result is hereinafter referred to as undefined result. The execution result in the pseudo model of the processor which outputs the expectation value when the zero division is executed is also the undefined result in general in a manner similar to the true circuit data.

Depending on data referenced when the instruction is executed by such a processor, the zero division may not be the only cause of the undefined result of the instruction. In an example of a computation device of the processor in recent years, restrictions are imposed on an input data value, and an execution result of the computation is not guaranteed when the restrictions are violated, so that power consumption and an area of the computation device are reduced. Even in such an example, the possibility that the execution result is undefined is never low in the verification method.

In the case where the instruction execution result is undefined (for example, zero division) in the circuit data and pseudo model of the processor, the compared expectation values are different to each other, which results in generation of a pseudo error. Then, when an instruction for referencing a memory device in which the undefined result is stored is thereafter executed, the execution of the instruction naturally generates a different result. Therefore, the undefined result unfavorably influences the simulation thereafter, which makes it not possible to continue the verification. In the verification environment where the instructions are randomly generated, in particular, the verification is halted when the undefined result is generated. As a result, it becomes difficult to execute such a large scale of simulation that numerous test patterns are continuously supplied, and the verification thereby fails to achieve a high quality.

As described, how the undefined result should be handled is a key issue in the verification method. The undefined result cannot be easily predicted at a time point when the instruction is supplied to the processor. In the case of the zero division, for example, a register number used as the divisor may be simply designated as an operand (item to be computed) in place of designating the divisor value itself as an immediate value in the division instruction. In such a case, the zero division occurs, not depending on the register value itself when the division instruction is supplied, but depending on the resister value when the division instruction is executed.

As is clear from the foregoing description, the undefined result is a parameter which is difficult to be predicted at the time of the supply of the instruction to the processor, and it is difficult to guarantee that the divisor is not zero at the time of the supply of the division instruction.

In the Patent Document 1, the test pattern in which the error is generated is registered in advance. However, it is still difficult to predict the test pattern in which the undefined result (zero division) is generated and previously register a generation pattern of the relevant undefined result even in the Patent Document 1 due to the described reason. Therefore, the foregoing problem has not been solved yet.

### Means for Solving the Problems

In order to solve the foregoing problem, in the present invention, a supplied instruction, a reference data referenced by the instruction and data restriction condition of the reference data are used in order to predict generation of an undefined result, and a simulating operation is halted when the undefined result is generated.

The simulating operation, which is once halted, remains halted until it is predicted that an execution result of the instruction is not any more undefined. Thereby, a control operation in relation to the halt/halt release of the simulating operation is significantly reduced, and reduction of a speed of the entire simulation due to the control operation can be controlled.

According to another mode of the present invention, when the instruction is supplied to an expectation value generating operation and an execution result (expectation value) of the instruction is undefined, the expectation value generating operation is shifted back to a state before the instruction is executed so that the simulation with respect to a verification object is halted.

According to still another mode of the present invention, the supplied instruction, the reference data referenced by the instruction and the data restriction condition of the reference data are used in order to predict the generation of the undefined result, wherein the instruction is replaced with another instruction when the undefined result is generated.

According to still another mode of the present invention, the supplied instruction, the reference data referenced by the instruction and the data restriction condition of the reference data are used in order to predict the generation of the undefined result, wherein a memory device in which the reference data designated as the operand of the instruction is stored is replaced with another memory device in which data satisfying the data restriction condition of the reference data is stored when the generation of the undefined result is predicted.

According to still another mode of the present invention, the supplied instruction, the reference data referenced by the instruction and a data restriction information in which the data restriction condition of the reference data is registered are used in order to predict the generation of the undefined result, wherein an instruction for updating the reference data to a value satisfying the data restriction condition is executed first to the memory device in which the reference data is stored when the undefined result is generated.

According to still another mode of the present invention, the supplied instruction, the reference data referenced by the instruction and the data restriction information in which the data restriction condition of the reference data is registered are used in order to predict the generation of the undefined result, wherein the reference data stored in the memory device is updated to the value satisfying the data restriction condition of the reference data when the undefined result is generated.

According to still another mode of the present invention, the supplied instruction, the reference data referenced by the instruction and the data restriction information in which the data restriction condition of the reference data is registered are used in order to predict the generation of the undefined result, wherein the execution result stored in the memory device is updated to an appropriate value when the undefined result is generated.

When the execution result is updated, the expectation value may be updated to a value equal to that of the simulation result, or the simulation result may be updated to a value equal to expectation value. Therefore, a function for updating the execution result may be provided in a simulation device to be verified or in an expectation value generating device.

According to still another mode of the present invention, the supplied instruction, the reference data referenced by the instruction and the data restriction information in which the data restriction condition of the reference data is registered are used in order to predict the generation of the undefined result, wherein an instruction generating device for generating the instruction based on instruction generation restriction is forced to issue an instruction for updating the memory device in which the undefined result is stored.

Referring to the forcible issuance of the instruction, instruction issuance restriction for forcibly issuing the instruction for updating the undefined result stored in the memory device is generated and given to the instruction generating device as additional instruction issuance restrictions.

Referring to the forcible issuance of the instruction, the instruction generating device is controlled to generate new restriction for forcibly issuing the instruction for updating the memory device in which the undefined result is stored.

Referring to the forcible issuance of the instruction, the instruction may not be issued immediately after the generation of the undefined result but can be issued anytime before the instruction referencing the undefined result is executed. Therefore, a timing of issuing the instruction for updating the memory device in which the undefined result is stored can have a certain degree of freedom. As a result, loss of randomness in the order in which the instructions are executed, due to the forcible issuance of the instruction can be prevented to a certain extent.

According to still another mode of the present invention, a reference data value of the instruction having the data restriction condition is used as the reference data so that candidates of the reference data which can be referenced by the instruction having the data restriction condition are determined, and the determined condition is used as the instruction issuance restriction, wherein the instruction based on the instruction issuance restriction thus generated is generated in the instruction generating device.

### Effect of the Invention

According to the present invention, the following effects are exerted:
generation of undefined result is controlled; and
simulation when and after the undefined result is generated is controlled so that any influence from the generation of the undefined result is removed,
so that interruption of verification due to a pseudo error can be prevented. As a result, the verification can achieve a high efficiency.

According to the present invention, such an inconvenience, for example, generated in verification of a processor that an instruction execution result is undefined because a value of a reference data referenced when the instruction is executed does not satisfy data restriction condition, which results in generation of the pseudo error when compared to an expectation value, can be prevented.

### BRIEF DESCRIPTION OF THE DRAWINGS

FIG. 1 is a block diagram of a constitution of a verification apparatus to which the present invention is implemented.

FIG. 2 is a flow chart of a conventional verification method in the verification apparatus according to the present invention.

FIG. 3 is a block diagram of a constitution of a verification apparatus according to a first preferred embodiment of the present invention.

FIG. 4 shows examples of data restriction condition.

FIG. 5 is a flow chart illustrating a general process of a verification method in the verification apparatus according to the first preferred embodiment.

FIG. 6 is a flow chart illustrating main steps of the verification method in the verification apparatus according to the first preferred embodiment.

FIG. 7 is a block diagram of a constitution of a verification apparatus according to a second preferred embodiment of the present invention.

FIG. 8 is a flow chart illustrating a general process of a verification method in the verification apparatus according to the second preferred embodiment.

FIG. 9 is a flow chart illustrating main steps of the verification method in the verification apparatus according to the second preferred embodiment.

FIG. 10 is a block diagram of a constitution of a verification apparatus according to a third preferred embodiment of the present invention.

FIG. 11 is a block diagram illustrating main steps of a verification method in the verification apparatus according to the third preferred embodiment.

FIG. 12 is a block diagram of a constitution of a verification apparatus according to a fourth preferred embodiment of the present invention.

FIG. 13 is a flow chart illustrating main steps of a verification method in the verification apparatus according to the fourth preferred embodiment.

FIG. 14 is a flow chart illustrating further main steps of the verification method in the verification apparatus according to the fourth preferred embodiment.

FIG. 15 is a block diagram of a constitution of a verification apparatus according to a fifth preferred embodiment of the present invention.

FIG. 16 is a flow chart illustrating main steps of a verification method in the verification apparatus according to the fifth preferred embodiment.

FIG. 17 is a flow chart illustrating further main steps of the verification method in the verification apparatus according to the fifth preferred embodiment.

FIG. 18 is a block diagram of a constitution of a verification apparatus according to a sixth preferred embodiment of the present invention.

FIG. 19 is a flow chart illustrating main steps of a verification method in the verification apparatus according to the sixth preferred embodiment.

FIG. 20 is a block diagram of a constitution of a verification apparatus according to a seventh preferred embodiment of the present invention.

FIG. 21 is a flow chart illustrating a general process of a verification method in the verification apparatus according to the seventh preferred embodiment.

FIG. 22 is a flow chart illustrating main steps of the verification method in the verification apparatus according to the seventh preferred embodiment.

FIG. 23 is a block diagram of a constitution of a verification apparatus according to an eighth preferred embodiment of the present invention.

FIG. 24 is a flow chart illustrating main steps of a verification method in the verification apparatus according to the eighth preferred embodiment.

FIG. 25 is a block diagram illustrating a constitution according to a modified embodiment of the eighth preferred embodiment.

FIG. 26 is a block diagram of a constitution of a verification apparatus according to a ninth preferred embodiment of the present invention.

FIG. 27 is a flow chart illustrating a general process of a verification method in the verification apparatus according to the ninth preferred embodiment.

FIG. 28 is a flow chart illustrating main steps of the verification method in the verification apparatus according to the ninth preferred embodiment.

FIG. 29 is a block diagram illustrating a constitution according to a modified embodiment of the ninth preferred embodiment.

### DESCRIPTION OF REFERENCE SYMBOLS

1A,1B,1C,1D,1E,1F,1G,1H,1J verification apparatus
2A,2B,2H,2H′,2J,2J′ main body of verification apparatus
3A,3B,3J extracting device
4A,4B,4C,4D,4E,1F,1G,1H,1J execution control device
5 circuit data unit
6 instruction supply device
7,7B simulation device
8,8B expectation value generating device
9 comparing device
10 simulation executing unit
11 first memory device
12 expectation value generating unit
13 second memory device
20 data restriction information storing unit
21 instruction analyzing device
22 reference data analyzing device
23A,23B,23C,23D,23E,23F control device
23G,23H,23H′,23J,23J′ control device
30 prior state shifting device
31 execution standby device
32 undefined result judging device
40 reference data candidate search device
41 reference data candidate analyzing device
42 reference data replacing device
43 instruction generating device
44 instruction placing device
50H,50H′,50J,50J′ instruction generation restriction creating device
51 instruction issuance restriction creating device
52 instruction generating device
60 reference data candidate determining device

### DETAILED DESCRIPTION OF THE INVENTION

Before preferred embodiments of the present invention are described, a constitution and a verification method of a verification apparatus 100 having the foregoing problems are described.

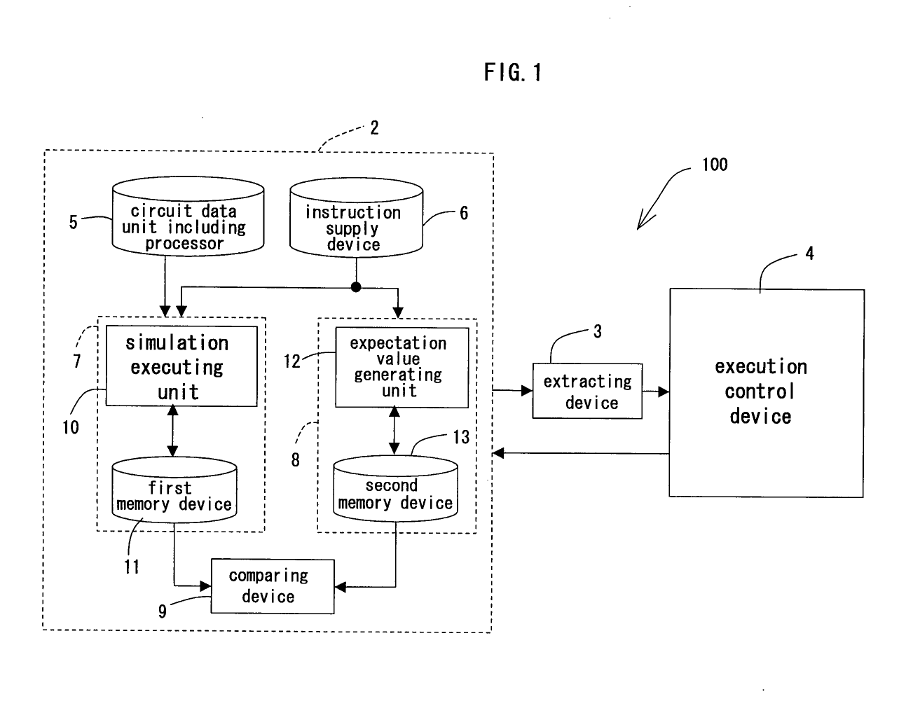

The constitution of the verification apparatus 100 is shown in FIG. 1. In FIG. 1, the verification apparatus 100 comprises a verification apparatus main body 2, an extracting device 3 for extracting a data information in the main body 2, and an execution control device 4 for receiving the data information from the extracting device 3 and controlling simulation so that any influence of an undefined result is controlled.

The main body 2 comprises a circuit data unit 5 including a processor, an instruction supply device 6 for outputting an instruction executable by the processor included in the circuit data unit 5, a simulation device 7 for simulating the instruction supplied from the instruction supply device 6 using the processor of the circuit data unit 5, an expectation value generating device 8 for generating an expectation value using the instruction, and a comparing device 9 for comparing a result of the simulation to the expectation value.

The simulation device 7 comprises a simulation executing unit 10 for executing the simulation, and a first memory device 11 for storing the simulation result and a reference data referenced when the instruction is executed. The expectation value generating device 8 comprises an expectation value generating unit 12 for executing the instruction supplied from the instruction supply device 6 and generating the expectation value, and a second memory device 13 for storing the reference data referenced when the instruction is executed by the expectation value generating unit 12 and the expectation value generated by the expectation value generating unit 12.

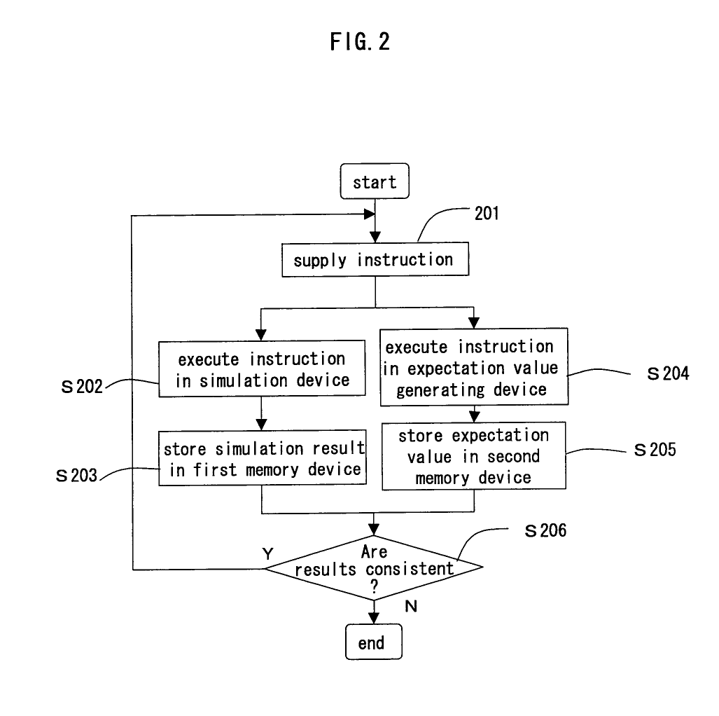

A verification method in which the main body 2 of the verification apparatus 2 is used is described referring to FIG. 2. FIG. 2 is a flow chart of the verification method using the verification apparatus 100. The verification method includes an instruction supply process (S201), a simulation process (S202, S203), an expectation value generating process (S204, S205) and a comparing process (S206). The instruction supply process S201 is a process in which the instruction supply device 6 supplies the instruction to the simulation device 7 and the expectation value generating device 8. The simulation process (S202, S203) is a process in which the simulation device 7 executes the simulation using the supplied instruction and stores a result of the simulation in the first memory device 11. The expectation value generating process (S204, S205) is a process in which the expectation value generating device 8 obtains the expectation value using the supplied instruction and stores the obtained expectation value in the second memory device 13. The comparing process S206 is a process in which the comparing device 9 reads the simulation result stored in the first memory device 11 and the expectation value stored in the second memory device 13 to thereby compare the read simulation result and the expectation value to each other.

The simulation process and the expectation value generating process are different to each other as follows. In the simulation process, the circuit data unit 5 described in a model description language, such as a hardware description language, is simulated with the simulation device 7 so that the simulation result is generated. In the expectation value generating process, a pseudo model of the circuit data unit 5 is prepared, and a test pattern identical to a test pattern given to the circuit data unit 5 is executed in the pseudo model so that the execution result (expectation value) is generated.

In the comparing process S206, the comparing device 9 halts the simulation when a result of the comparison shows inconsistency and notifies a user of the result showing the inconsistency. On the contrary, when the comparison result shows consistency, the comparing device 9 outputs a command for supplying a new instruction to the simulation device 7 and the expectation value generating device 8 to the instruction supply device 6. The instruction supplied by the instruction supply device 6 to the simulation device 7 and the expectation value generating device 8 in the instruction supply process S201 may be an instruction data generated and inputted to the instruction supply device 6 by the user him/herself, or an instruction data randomly generated in the instruction supply device 6.

In the foregoing verification method, the simulation continues unless the simulation result and the expectation value are different to each other. However, the comparison result shows the inconsistency in the comparing process in the case where the instruction execution result is undefined as described earlier. Then, it is determined that a pseudo error is generated in the comparing process, and the simulation is thereby halted. Further, when the instructions referencing the undefined result are executed in the simulation thereafter, the respective execution results are naturally different to each other since the different reference data are thereby referenced, and the comparison result in the comparing process shows the inconsistency. As a result, the simulation is discontinued when and after the undefined result is generated.

As described, in the verification method shown in FIG. 2, the simulation is unfavorably halted due to the pseudo error caused by the undefined result other than the simulation halt due to a true error. In the verification method in which the instruction is randomly generated in the instruction supply process, in particular, the simulation may not be continuously executed in the case where the undefined result is frequently generated.

### First Preferred Embodiment

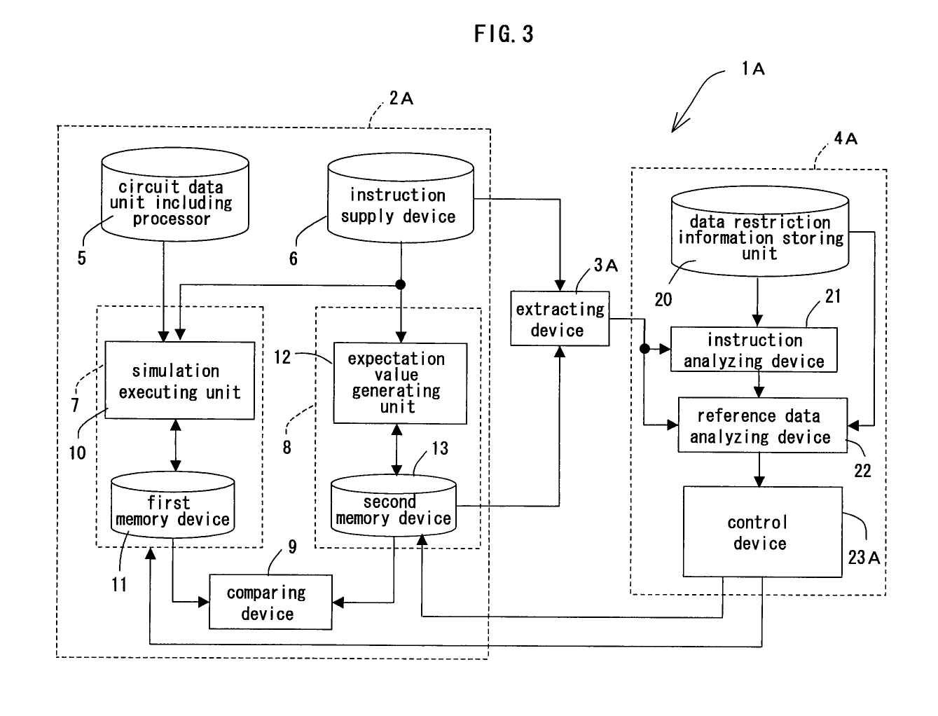

FIG. 3 shows a constitution of a verification apparatus 1A according to a first preferred embodiment of the present invention. The constitution of the verification apparatus 1A is basically similar to that of the verification apparatus 100 described earlier, and any identical or similar component is simply provided with the same reference symbol and not described again. However, those which similarly operate but include any slightly different operation are provided with “A” at the end of their reference symbols to be thereby discriminated from the components of the verification apparatus 100.

The characteristic of the constitution of the verification apparatus 1A is described below. The verification apparatus 1A according to the present preferred embodiment comprises a verification apparatus main body 2A, an extracting device 3A and an execution control device 4A. The main body 2A of the verification apparatus is basically constituted in a manner similar to the verification apparatus 2 of the verification apparatus 100. The second memory device 13 stores therein the reference data referenced when the instruction is executed by the expectation value generating unit 12 and the expectation value which is the instruction execution result obtained from the expectation value generating unit 12. In a generally available processor, a general-purpose register constitutes the second memory device 13.

The extracting device 3A extracts the reference data stored in the second memory device 13 and the instruction outputted by the instruction supply device 6 and supplies the extracted data and instruction to the execution control device 4A.

The execution control device 4A comprises a data restriction information storing unit 20, an instruction analyzing device 21, a reference data analyzing device 22 and a control device 23A. In the data restriction information storing unit 20, restriction condition of the instruction are registered. The restriction condition of the instruction are restriction condition of the reference data referenced when the instruction is executed by the simulation executing unit 10 and the expectation value generating unit 12. The instruction analyzing device 21 analyzes details of the instruction (extracted by the extracting device 3A) based on the restriction information stored in the data restriction information storing unit 20. The reference data analyzing device 22 analyzes details of the reference data (extracted by the extracting device 3A) based on the data restriction information stored in the data restriction information storing unit 20 and a result of the instruction analysis by the instruction analyzing device 21. The control device 23A controls the simulation device 7 and the expectation value generating device 8 based on a result of the analysis by the reference data analyzing device 22.

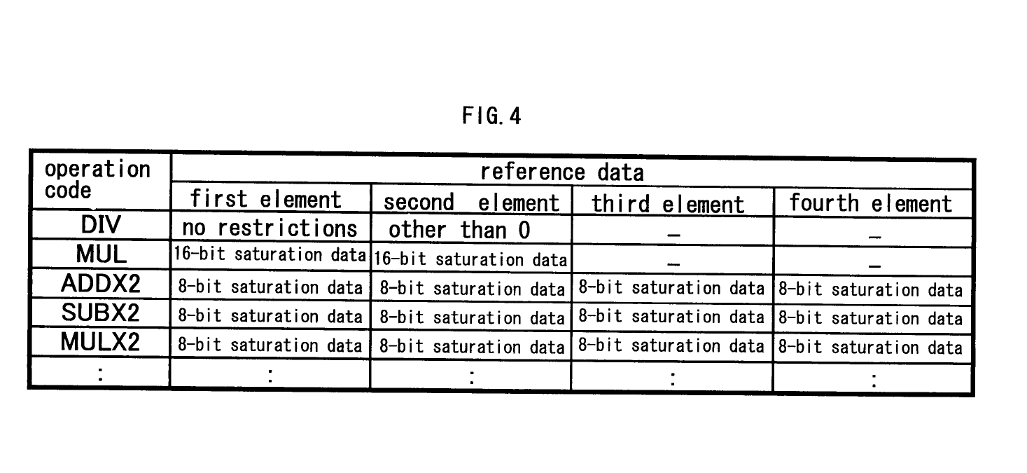

FIG. 4 shows the data restriction information stored in the data restriction information storing unit 20. The data restriction information stored in the data restriction information storing unit 20 includes the instruction and the restriction condition of the instruction. The instruction recited in this specification is an instruction executed by the processor included in the circuit data unit 5 and an instruction having the restriction condition in the reference data referenced when the instruction is executed. In the data restriction information storing unit 20, the instruction having the restriction condition and the restriction condition are selectively stored. In FIG. 4, each instruction is classified by operation code.

In the case of an DIV instruction (division instruction), a register number of the general-purpose register in which a dividend is stored as a first element of an operand and a divisor is stored as a second element thereof is designated, and the restriction condition of the reference data of the relevant instruction are shown in FIG. 4. In the present case, the divisor as the second element being any value other than zero is registered as the restriction condition. Regarding other instructions (MUL, ADDX2, SUBX2, MULX2, . . . ), the restriction condition of the reference data designated in the respective operands thereof are registered.

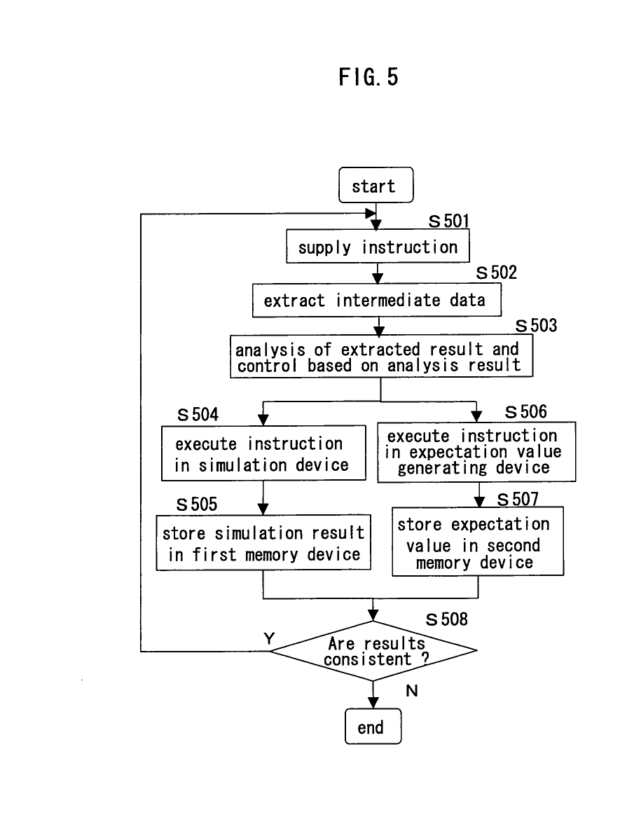

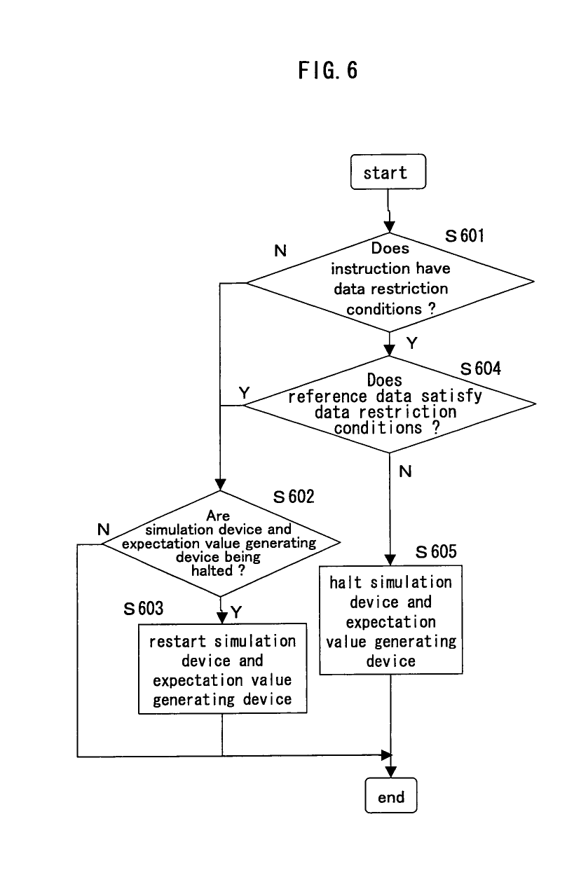

A verification method in which the verification apparatus 1A is used is described referring to flow charts shown in FIGS. 5 and 6. First, the instruction supply device 6 supplies the instruction to the simulation executing unit 10 and the expectation value generating unit 12 (S501). At that time, the instruction supply device 6 also outputs the instruction to be supplied to the extracting device 3A. The extracting device 3A extracts an intermediate data included in the supplied instruction (S502). In the verification apparatus 1A, the intermediate data specifically includes the instruction per se and the reference data referenced when the relevant instruction is executed.

The extracting device 3A outputs the extracted intermediate data to the execution control device 4A. The execution control device 4A executes the following processings using the inputted intermediate data. First, the instruction analyzing device 21 analyzes the intermediate data. The control device 23A controls the main body 2A of the verification apparatus (switchover between continuation and temporary halt of the operation) based on a result of the analysis (S503).

When the control operation in the step S503 is the temporary halt of the instruction execution, the main body 2A of the verification apparatus temporarily halts the verifying operation in accordance with the control operation. When the control operation in the step S503 is the continuation of the operation, the main body 2A of the verification apparatus executes a processing similar to the simulation conventionally executed. More specifically, the main body 2A of the verification apparatus executes the instruction supplied from the instruction supply device 6 in the simulation device 7 and the expectation value generating device 8 (S504, S506), and stores execution results thereby obtained (simulation result and expectation value) in the first memory device 11 and the second memory device 13 (S505, S507). The execution results stored in the first memory device 11 and the second memory device 13 are compared in the comparing device 9 whether or not they are consistent with each other (S508). Then, the respective steps of the simulation are completed.

Next, a control operation based on the analysis of the intermediate data and the analysis result thereby obtained, which is a characteristic of the verification apparatus 1A, is described referring to a flow chart shown in FIG. 6. First, it is judged in the instruction analyzing device 21 whether or not the intermediate data received from the extracting device 3A has the restriction condition (S601). The presence or absence of the restriction condition is more specifically determined when it is judged whether or not the intermediate data corresponds to the instruction with the restriction stored (registered) in the data restriction information storing unit 20.

When a result of the judgment made in S601 shows that the intermediate data does not correspond to the registered instruction (instruction with the restriction), the instruction analyzing device 21 notifies the control device 23a of the result showing the non-correspondence. The control device 23A which received the notification of the result decides that the relevant instruction does not possibly generate the undefined result. Then, the control device 23A judges whether or not the operations of the simulation device 7 and the expectation value generating device 8 are temporarily being halted (S602). When a result of the judgment shows that the operations are not temporarily being halted, the control device 23A does not control the simulation device 7 and the expectation value generating device 8. The control operation hereby recited refers to the temporary halt of the simulation device 7 and the expectation value generating device 8. When the judgment result in S602 shows that the operations are temporarily being halted, the control device 23A restarts the operations of the simulation device 7 and the expectation value generating device 8 (S603).

When the judgment result in S601 shows that the intermediate data corresponds to the registered instruction (instruction with the restriction), the instruction analyzing device 21 notifies the reference data analyzing device 22 of the result showing the correspondence. The reference data analyzing device 22 which received the notification of the result conducts the following analysis. First, the reference data analyzing device 22a extracts a register value of the register number designated in the operand of the relevant instruction from the reference data included in the intermediate data, and further, judges whether or not the extracted register value satisfies the data restriction condition (registered in the data restriction information stored in the data restriction information storing unit 20), and notifies the control device 23A of a result of the judgment (S604).

When the judgment result notified in consequence of the processing in S604 satisfies the data restriction condition showing non-violation, the control device 23A decides that the relevant instruction does not possibly generate the undefined result, and implements the steps S602 and S603, that is, the simulation device 7 and the expectation value generating device 8 are not controlled (not temporarily halted).

When the judgment result notified in consequence of the processing in S604 does not satisfy the data restriction condition showing violation, the control device 23A decides that the relevant instruction possibly generates the undefined result, and controls (temporary halts) the simulation device 7 and the expectation value generating device 8 (S605).

When the steps S602, S603 and S605 are implemented, the following effects are obtained. During a period when the instructions possibly generating the undefined result are continuously supplied, the control device 23A leaves the simulation device 7 and the expectation value generating device 8 in the temporarily-halt state, and releases the temporary halt (restarts the operation) when the supply of the instruction not possibly generating the undefined result starts. Thus, the control device 23A keeps the simulation device 7 and the expectation value generating device 8 in the temporary-halt state during the period when the instructions judged to generate the undefined result are continuously supplied to thereby minimize an amount of time consumed for halting and halt-releasing these devices 7 and 8, so that a general speed of the simulation is prevented from reducing.

As described so far, the verification apparatus 1A according to the present preferred embodiment halts the simulation device 7 and the expectation value generating device 8 immediately before the instruction whose execution result is undefined is executed to thereby prevent the execution of the relevant instruction. As a result, any inconvenience resulting from the execution of the instruction whose execution result is undefined can be prevented.

### Second Preferred Embodiment

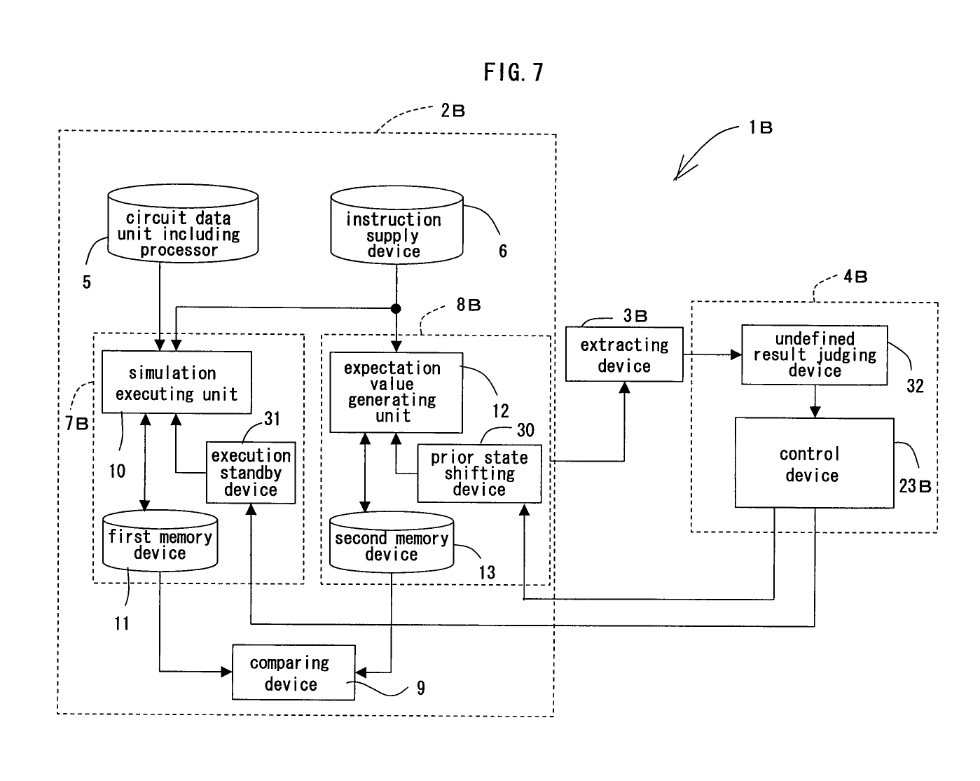

FIG. 7 is a block diagram of a constitution of a verification apparatus 1B according to a second preferred embodiment of the present invention. The expectation value generating device 1B is basically constituted in a manner similar to that of the first preferred embodiment, and any similar or identical component is simply provided with the same reference symbol as in the first preferred embodiment and not described again. However, those which similarly operate but include any slightly different operation are provided with “B” at the end of their reference symbols to be thereby discriminated from the component in the first preferred embodiment.

The verification apparatus 1B is characterized in comprising a prior state shifting device 30, an execution standby device 31 and an undefined result judging device 32. The prior state shifting device 30 is a device for shifting a state of an expectation value generating device 8B back to a state prior to the execution of the last instruction. The operation of the prior state shifting device 30 is realized as follows. Recording contents of the second memory device 13 in the expectation value generating device 8B are temporarily retained immediately before the instruction is executed. Then, the retained data is changed back to the recording contents of the second memory device 13 after the instruction is executed. Thereby, the prior state shifting device 30 can shift the state of the expectation value generating device 8B to the state prior to the execution of the last instruction.

The execution standby device 31 is provided in a simulation device 7B. The execution standby device 31 halts the execution of the instruction by the simulation device 7B until a standby release notice is received from an execution control device 4B. In the second preferred embodiment, the instruction is selectively executed in the expectation value generating device 8B prior to the simulation device 7, and the execution result thereby obtained is extracted by an extracting device 3B.

The undefined result judging device 32 judges whether or not the execution result is undefined from the extracted information obtained by the extracting device 3B. In the case where the expectation value generating device 12 creates a flag for notifying the generation of the undefined execution result, the undefined result judging device 32 can determine the generation of the undefined result based on detection of the flag. Further, the generation of the undefined execution result can be detected when the instruction and the reference data referenced when the instruction is executed are analyzed in a manner similar to the verification apparatus 1A according to the first preferred embodiment.

A control device 23B executes the following control operation based on the judgment result of the undefined result judging device 32. When the execution result of the instruction executed by the expectation value generating device 8B is undefined, the control device 23B operates the prior state shifting device 30 to thereby shift the state of the expectation value generating device 8B back to the state before the instruction is executed. Because the instruction is first executed by the expectation value generating device 8B, the simulation device 7B has not yet executed the instruction at the time of judging whether or not the instruction execution result is undefined. The control device 23B, which found out that the instruction execution result is undefined at this timing, does not allow the simulation device 7B to execute the instruction judged to generate the undefined result.

In the verification apparatus 1B, the expectation value generating device 8B is shifted back to the state before the instruction is executed based on the earlier decision of the instruction execution result as undefined, and further halts the execution of the instruction by the simulation device 7B. More specifically, the verification apparatus 1B makes the expectation value generating device 8B precede the other device in executing the instruction to thereby decide that the execution result is undefined, and then resets the expectation value generating device 8B and halts the execution of the instruction by the simulation device 7B based on the obtained judgment result. Thereby, the verification apparatus 1B prevents the execution of the instruction whose execution result is undefined because the reference data violates the data restriction condition.

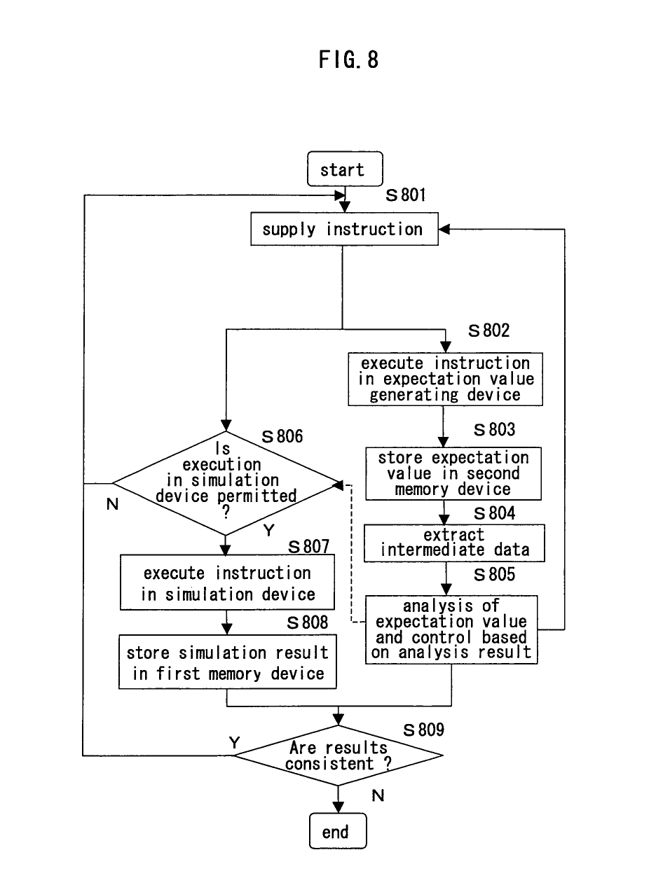

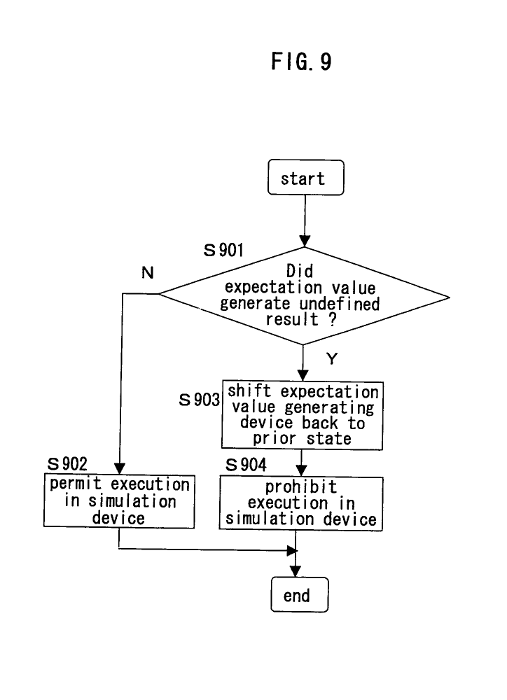

Below is described a verification method in which the verification apparatus 1B is used referring to flow charts shown in FIGS. 8 and 9. FIG. 8 is a flow chart of a general operation of the verification apparatus 1B. FIG. 9 is a flow chart in which the operations of the undefined result judging device 32 and the control device 23B are extracted and shown.

First, the instruction supply device 6 supplies the instruction to the simulation executing unit 10 and the expectation value generating unit 12 (S801).

The expectation value generating device 8B executes the instruction in the expectation value generating unit 12, and memorizes the expectation value showing the execution result thereof in the second memory device 13 (S802, S803). At this point of time, the simulation device 7B is on standby for the execution of the instruction.

The expectation value, which is the instruction execution result of the expectation value generating unit 12, is extracted by the extracting device 3B and supplied to the undefined result judging device 32 (S804).

The undefined result generating device 32 analyzes the information obtained from the expectation value generating unit 12 to thereby judge whether or not the expectation value is undefined. The control device 23B controls the simulation device 7 and the expectation value generating device 8 based on a result of the analysis (S805).

Details of the step S805 are described referring to the flow chart shown in FIG. 9. First, the undefined result judging device 32 analyzes the obtained from the expectation value generating unit 12 to thereby judge whether or not the expectation value is undefined (S901). A result of the judgment is supplied to the control device 23B.

The control device 23B executes the following control operation based on the judgment result of the undefined result judging device 32. The control device 23B transmits a control signal of the simulation device 7B to the simulation device 7B based on the judgment result of the instruction execution result (expectation value). Describing the control signal, the control signal serves as a signal for permitting the execution of the instruction by the simulation device 7B when the instruction execution result (expectation value) does not include the undefined result (S902), while serving as a signal for shifting the state of the expectation value generating device 8B back to the state before the instruction is executed and prohibiting (not permitting) the execution of the instruction by the simulation device 7B when the instruction execution result (expectation value) includes the undefined result (S904).

Referring back to the flow chart of FIG. 8, the operations of the simulation device 7B which received the control signal and the expectation value generating device 8B are described. The expectation value generating device 8B executes the instruction prior to the simulation device 7B, and the simulation device 7B has not yet executed the instruction at this point (time point when the control signal is received from the control device 23B). The execution standby device 31 which received the control signal judges the contents of the received control signal (S806) and controls the simulation device 7B based on a result of the judgment as follows.

When the received control signal shows the prohibition (non-permission) of the instruction execution, the execution standby device 31 does not start the execution of the instruction by the simulation executing unit 10 leaving it continuously halted in accordance with the command. The execution standby device 31 further returns to the step S801 and remains standby while judging whether or not the next instruction is supplied from the instruction supply device 6.

When the received control signal shows the permission of the execution of the instruction, the execution standby device 31 starts the simulation similar to that of the conventional technology in a main body 2B of the verification apparatus (S807), and stores the execution result (simulation result) by the simulation executing unit 10 in the first memory device 11 (S808). The execution results stored in the first memory device 11 and the second memory device 13 are compared to judge whether or not they are consistent with each other in the comparing device 9 (S809). Then, the entire steps of the simulation are completed.

As described, the verification apparatus 1B resets the expectation value generating device 8B and halts the execution of the instruction by the simulation device 7B based on the judgment result on the expectation value as undefined obtained through the preceding execution of the instruction. More specifically, the verification apparatus 1B shifts the state of the expectation value generating device 8B back to the state before the instruction is executed and halts the execution of the instruction by the simulation device 7B based on the judgment result on whether or not the execution result of the instruction precedingly executed in the expectation value generating unit 12. Therefore, the execution of the instruction whose execution result is undefined is prevented in the verification apparatus 1B. As a result, the discontinuation of the verification due to the pseudo error can be prevented, and the verification can be thereby more efficient.

### Third Preferred Embodiment

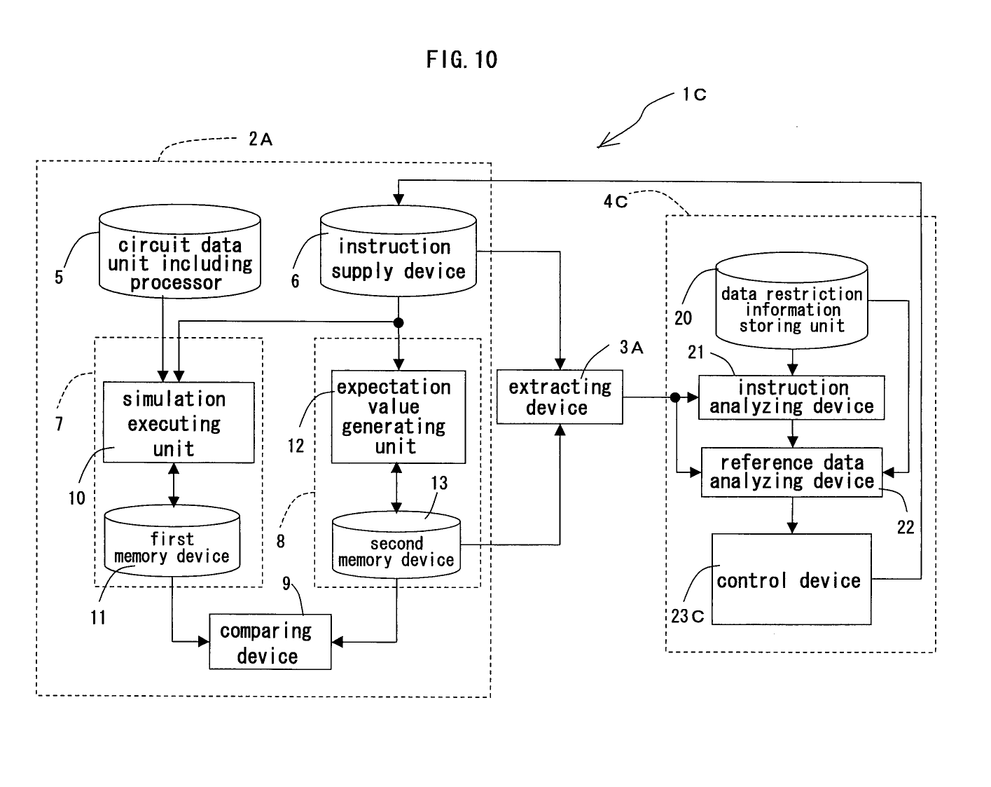

FIG. 10 is a block diagram of a constitution of a verification apparatus 1C according to a third preferred embodiment of the present invention. A constitution of the verification apparatus 1C is basically similar to that of the verification apparatus 1A according to the first preferred embodiment. Therefore, any identical or similar part is simply provided with the same reference symbol as recited in the first preferred embodiment and not described again. However, those which similarly operate but include any slightly different operation are provided with “C” at the end of their reference symbols to be thereby discriminated from the components of the verification apparatus 1A. More specifically, the verification apparatus 1C is characterized in a control method of a control device 23C. The control method is different to that of the control device 23A of the verification apparatus 1A.

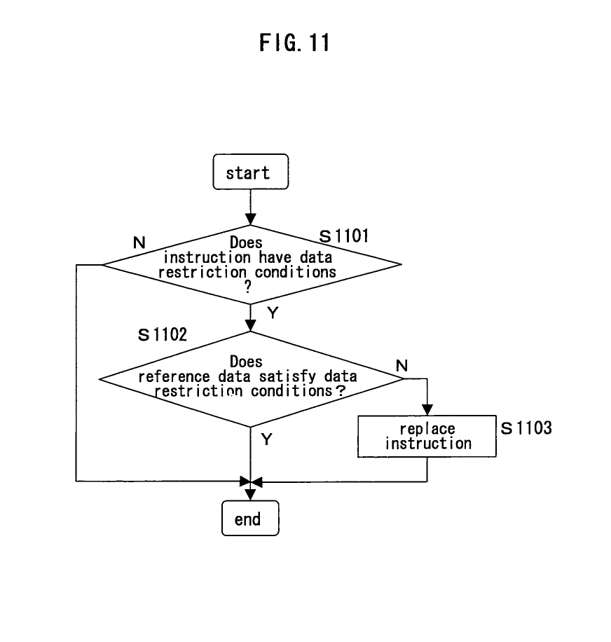

FIG. 11 shows a flow chart of a verification method in which the verification apparatus 1C is used. A general control operation of the verification apparatus 1C is the same as that of the verification apparatus 1A shown in the flow chart of FIG. 5. However, the verification apparatus 1C is slightly different to the verification apparatus 1A in the analysis of the intermediate data and the control operation based on the obtained analysis result in the step S503.

The flow chart of FIG. 11 shows the analysis of the intermediate data and the control operation based on the obtained analysis result in which the verification apparatus 1C is characterized. The extracting device 3A supplies the extracted intermediate data to the instruction analyzing device 21 and the reference data analyzing device 22.

The instruction analyzing device 21 judges whether or not the intermediate data received from the extracting device 3 has the restriction condition (S1101). The presence or absence of the restriction condition is more specifically decided based on the judgment on whether or not the intermediate data corresponds to the instruction stored (registered) in the data restriction information storing unit 20.

When a result of the judgment in the step S1101 shows that the intermediate data does not correspond to the registered instruction, the instruction analyzing device 21 notifies the control device 23C of the result showing the non-correspondence. The control device 23C which was notified of the result determines that the relevant instruction does not possibly generate the undefined result. The control device 23C thus determined does not control the simulation device 7 and the expectation value generating device 8. Accordingly, the simulation device 7 and the expectation value generating device 8 execute the instruction.

When the judgment result in the step S1101 shows that the intermediate data corresponds to the registered instruction (instruction with the restriction), the instruction analyzing device 21 notifies the reference data analyzing device 22 of the result showing the correspondence. The reference data analyzing device 22 which was notified of the result conducts the following analysis. The reference data analyzing device 22 extracts the register value of the register number designated in the operand of the relevant instruction from the reference data included in the intermediate data supplied from the extracting device 3A. The reference data analyzing device 22 further judges whether or not the extracted register value satisfies the data restriction condition (registered in the data restriction information stored in the data restriction information storing unit 20), and notifies the control device 23C of a result of the judgment (S1102).

When the judgment result notified in the step S1102 shows that the data restriction condition is satisfied and not violated, the control device 23C decides that the relevant instruction does not possibly generate the undefined result, and does not control the simulation device 7 and the expectation value generating device 8. Accordingly, the simulation device 7 and the expectation value generating device 8 execute the instruction.

When the judgment result notified in the step S1102 shows that the data restriction condition fails to be satisfied and violated, the control device 23C decides that the relevant instruction possibly generates the undefined result. The control device 23C having made the foregoing decision replaces the relevant instruction with another instruction not having the data restriction condition (S1103). An example of the instruction not having the data restriction condition is an NOP (No operation) instruction, which replaces the instruction whose execution result is undefined. The another instruction replacing the instruction is supplied from the control device 23C to the simulation device 7 and the expectation value generating device 8 via the instruction supply device 6.

The simulation device 7 and the expectation value generating device 8 execute the replaced instruction. Thereby, the instruction not having the data restriction condition and not possibly affecting the simulation is executed in the simulation device 7 and the expectation value generating device 8. As a result, the interruption of the verification due to the pseudo error can be prevented, and the verification can be thereby more efficient.

In the verification apparatus 1A according to the first preferred embodiment, the simulation device 7 and the expectation value generating device 8 are halted when the executed instruction generates the undefined result. In contrast to that, the instruction whose execution result is undefined is replaced with another instruction not having the data restriction condition in the verification apparatus 1C according to the present preferred embodiment. When the instruction whose execution result is undefined is replaced with such an instruction, the instruction can be executed in such a manner that the simulation is free of any influence in the absence of the data restriction condition. As a result, the interruption of the verification due to the pseudo error can be prevented, and the verification can be thereby more efficient.

The verification apparatus 1C according to the third preferred embodiment executes the same control operation as that of the verification apparatus 1A according to the first preferred embodiment other than the replacement of the instruction in the case where the instruction generates the undefined execution result.

### Fourth Preferred Embodiment

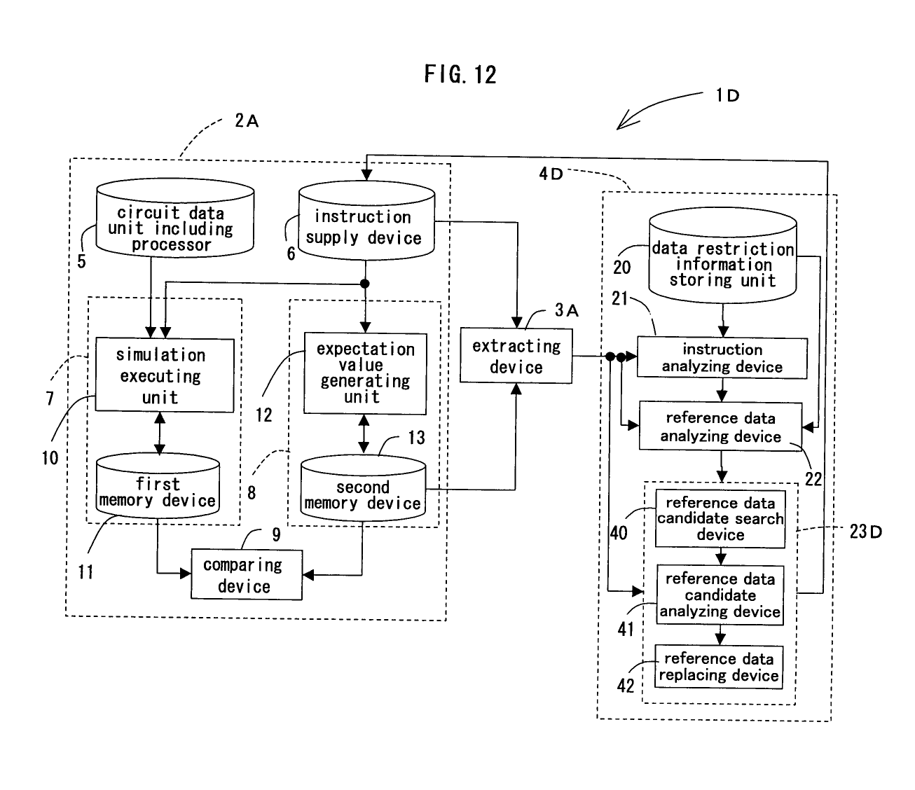

FIG. 12 is a block diagram of a constitution of a verification apparatus 1D according to a fourth preferred embodiment of the present invention. The verification device 1D is basically constituted in a manner similar to the verification apparatus 1C according to the third preferred embodiment, and any similar or identical component is simply provided with the same reference symbol as in the third preferred embodiment and not described again. However, those which similarly operate but include any slightly different operation are provided with “D” at the end of their reference symbols to be thereby discriminated from the components of the verification apparatus 1C. More specifically, the verification apparatus 1D is characterized in a constitution and a control method of a control device 23D. The constitution and the control method are different to those of the control device 23C of the verification apparatus 1C.

A general control method (verification method) of the verification apparatus 1D is identical to the control method (verification method) of the verification apparatus 1C according to the third preferred embodiment described referring to the flow chart shown in FIG. 5. The description of the general control method (verification method) of the verification apparatus 1D is, therefore, is omitted.

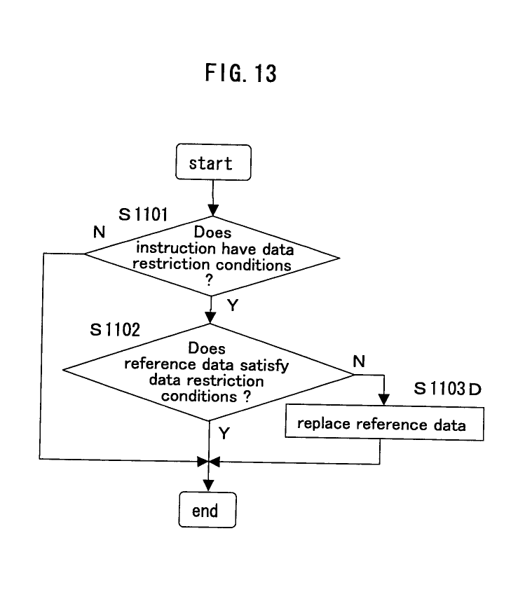

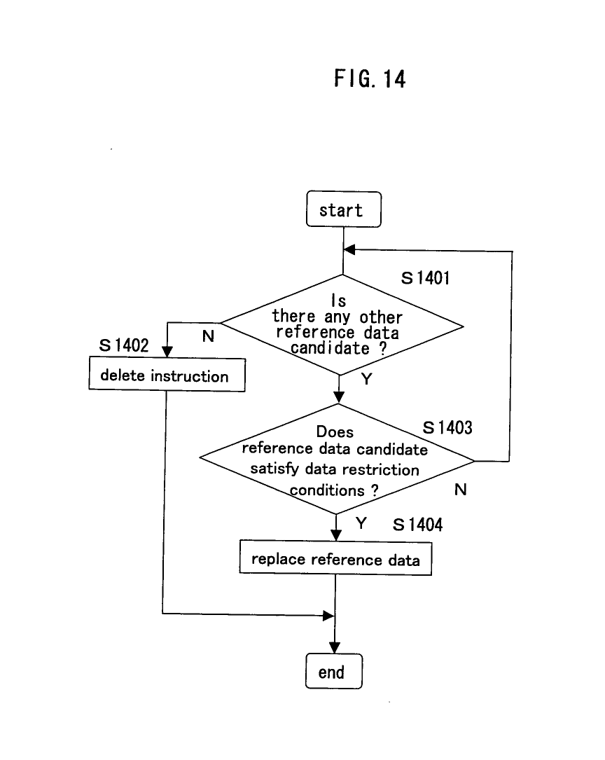

The control device 23D of the verification apparatus 1D according to the present preferred embodiment is characterized in replacing the reference data referenced when the instruction is executed with another reference data when the instruction execution result is judged to be undefined. FIGS. 13 and 14 show main steps in the control operation of the verification apparatus 1D. These main steps are basically similar to those of the verification apparatus 1C according to the third preferred embodiment, and the same steps are provided with the same reference symbols. The verification apparatus 1F is, however, different to the verification apparatus 1C as follows.

In the verification apparatus 1C according to the third preferred embodiment, the instruction whose execution result is undefined is replaced with another instruction not having the data restriction condition as shown in the step S1103 of FIG. 11. In the verification apparatus 1D according to the present preferred embodiment, a step S1103D in which the reference data is replaced is adopted in place of the replacement of the instruction as shown in FIG. 13.

In the verification apparatus 1D, the reference data referenced at the time of the execution of the instruction whose execution result is undefined is replaced with another data that can serve as the reference data. More specifically, the register number of the data referenced when the instruction is executed is changed to another register number capable of acquiring a place of the reference data (register number of the general-purpose register) designated in the operand of the instruction (referred to as a reference data candidate in the fourth preferred embodiment). The foregoing replacement is the step S110D in which the reference data is replaced.

In order to execute the foregoing control operation, the control device 23D of the verification apparatus 1D comprises a reference data candidate search device 40 for searching the reference data candidate, a reference data candidate analyzing device 41 for analyzing whether or not the searched reference data candidate satisfies the data restriction condition, and a reference data replacing device 42 for replacing the reference data with the reference data candidate when the reference data candidate satisfies the data restriction condition.

Details of the step S1103 in which the reference data is replaced in the control device 23D are described referring to a flow chart shown in FIG. 14.

In the operand of the instruction executed by the processor, the register number in which the reference data referenced when the instruction is executed is stored is generally designated. When the reference data analyzing device 22 renders the judgment that the instruction execution result is undefined, first, any replaceable register number is searched based on the register number of the reference data of the instruction whose execution result is undefined (S1401) The search operation is executed by the reference data candidate search device 40.

When any replaceable register number is judged to be absent in S1401, the instruction is deleted (S1402). The instruction is deleted by the reference data replacing device 42.

When any replaceable register number is judged to be present in S1401, it is judged whether or not the reference data candidate located at the register number as the replacement candidate satisfies the data restriction condition (S1403). The judgment is made by the reference data candidate analyzing device 41. When the reference data candidate is judged to satisfy the data restriction condition in S1403, the reference data whose execution result is undefined is replaced with the reference data candidate. In other words, in the case of the reference data used in the instruction, the candidate whose execution result is judged to be undefined is replaced with the candidate whose execution result is judged to be defined (S1404). The replacement is executed by the reference data replacing device 42.

When it is judged in S1043 that the reference data candidate fails to satisfy the data restriction condition, it is judged whether or not there is any other reference data in S1401 again. The operations of S1401-S1404 are implemented so that the reference data is replaced with the data satisfying the data restriction condition.

In general, a plurality of general-purpose registers is provided in the processor, and the register number designated in the operand of the instruction is replaceable. Such a characteristic of the processor is utilized to replace the reference data with the data satisfying the data restriction condition in the verification apparatus 1D. In the case where the replacement is not possible, any countermeasure proposed in the other preferred embodiments of the present invention, for example, the replacement of the instruction according to the third preferred embodiment can be adopted.

As described, the reference data of the instruction whose execution result is undefined is replaced with another data in the verification apparatus 1D, which prevents the execution of the instruction whose execution result is undefined. As a result, the interruption of the verification due to the pseudo error can be prevented so that the efficiency of the verification can improved.

### Fifth Preferred Embodiment

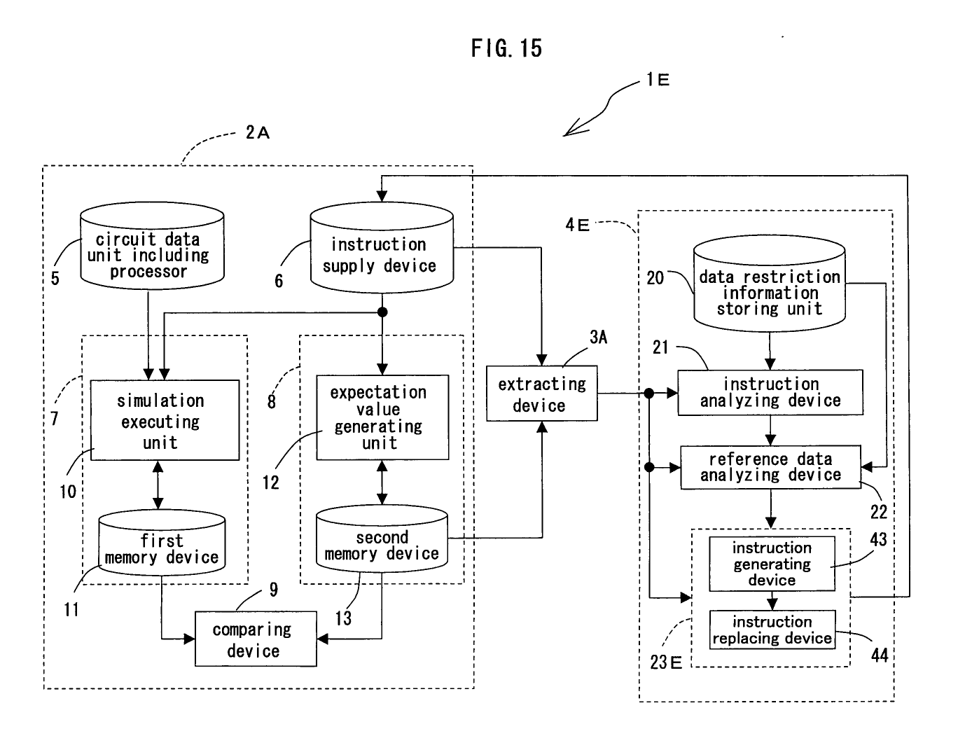

FIG. 15 is a block diagram of a constitution of a verification apparatus 1E according to a fifth preferred embodiment of the present invention. The verification device 1E is basically constituted in a manner similar to the verification apparatus 1C according to the third preferred embodiment, and any similar or identical component is simply provided with the same reference symbol as in the verification apparatus 1C according to the third preferred embodiment and not described again. However, those which similarly operate but include any slightly different operation are provided with “E” at the end of their reference symbols to be thereby discriminated from the components of the verification apparatus 1C.

The verification apparatus 1E is characterized in a constitution and a control method of a control device 23E. The control device 23E comprises an instruction generating device 43 and an instruction placing device 44. The control device 23E is different to the control device 23C of the verification apparatus 1C in that these devices 43 and 44 are provided and used in the control method.

A general control method (verification method) of the verification apparatus 1E is identical to the control method (verification method) of the verification apparatus 1C according to the third preferred embodiment described referring to the flow chart shown in FIG. 5. The description of the general control method (verification method) of the verification apparatus 1E is, therefore, omitted.

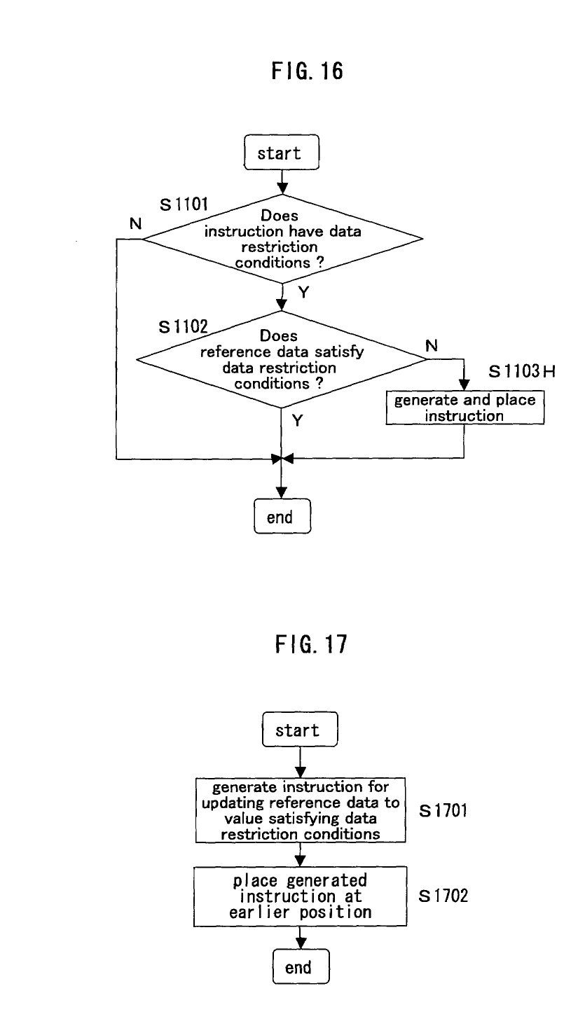

The control device 23E of the verification apparatus 1E according to the present preferred embodiment is characterized in that an instruction for changing the reference data is newly generated when the instruction execution result is judged to be undefined, and the generated instruction for changing the reference data is placed at a position where the generated instruction is executed prior to the instruction whose execution result is undefined. FIG. 16 shows main steps of the control method (verification method) in which the verification apparatus 1E is used. The general control operation of the verification apparatus 1E is basically similar to the control method (verification method) of the verification apparatus 1C according to the third preferred embodiment described referring to the flow chart shown in FIG. 5. Therefore, the same steps are provided with the same reference symbols. The verification apparatus 1E is, however, different to the verification apparatus 1C as follows.

The control device 23E carries out a step S1103H in which the instruction for changing the reference data is newly generated when the instruction execution result is judged to be undefined, and the generated instruction for changing the reference data is placed at the position where it is executed prior to the instruction whose execution result is undefined. Details of the generation and the placement of the instruction executed in the verification apparatus 1E are described referring to a flow chart shown in FIG. 17.

First, an instruction for updating the place of the reference data designated in the operand of the instruction (register number of the general-purpose register) with a value within the range of the data restriction condition of the relevant instruction is generated (S1701). This operation is implemented by the instruction generating device 43. The update instruction is placed prior to the instruction whose execution result is undefined (S1702). This operation is implemented by the instruction placing device 44. The instruction thus changed is supplied from the control device 23E to the expectation value generating device 8 via the instruction supply device 6 and executed in the expectation value generating device 8.

Accordingly, the instruction referencing the data not satisfying the data restriction condition is replaced with the instruction referencing the data satisfying the data restriction condition, and the replaced instruction is executed in the expectation value generating device 8 and the simulation device 7. As a result, the generation of the undefined result can be prevented.

The reference data update instruction generated in the instruction generating device 43 is generated as follows. For example, a memory access instruction for storing the update data satisfying the data restriction condition in the register is generated as the reference data update instruction, in which case it is necessary to previously store the value of the update data satisfying the data restriction condition per instruction in a data memory or the like. Further, an MOV instruction for designating the value satisfying the data restriction condition as an immediate value in the operand is generated as the reference data update instruction.

Accordingly, the instruction for updating the reference data of the instruction whose execution result is undefined to the data of the instruction whose execution result is defined is generated, and the generated reference data update instruction is executed prior to the instruction whose execution result is undefined. Thereby, the generation of the undefined result can be prevented. As a result, the interruption of the verification due to the pseudo error can be prevented, which improves the efficiency of the verification.

### Sixth Preferred Embodiment

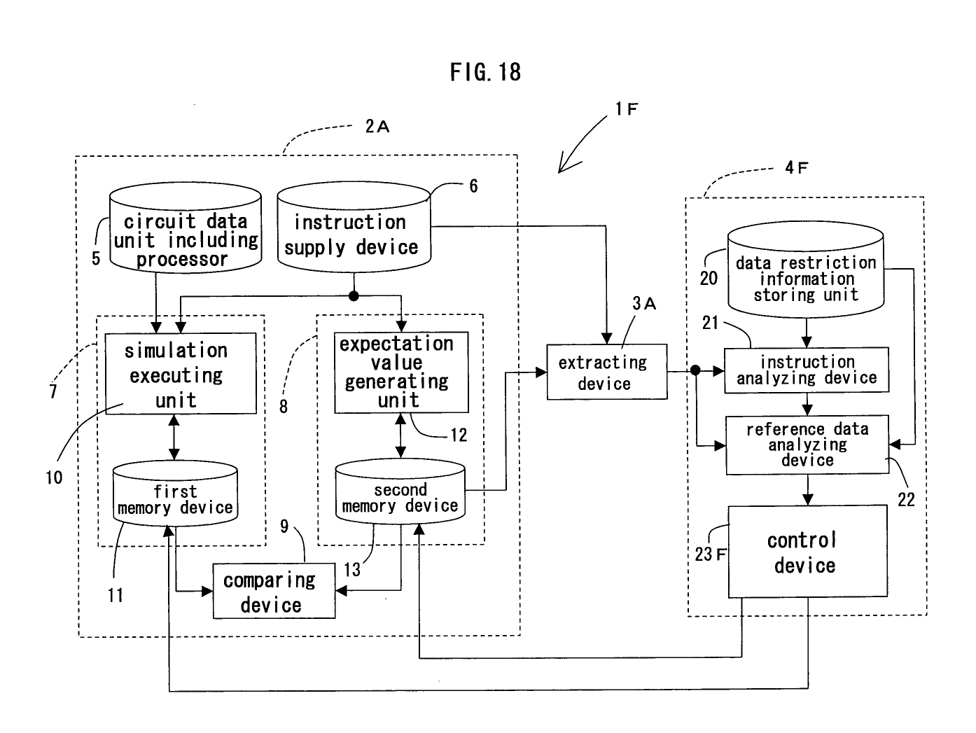

FIG. 18 is a block diagram of a constitution of a verification apparatus 1F according to a sixth preferred embodiment of the present invention. A constitution of the verification apparatus 1F is basically similar to that of the verification apparatus 1C according to the third preferred embodiment. Therefore, any identical or similar part is simply provided with the same reference symbol as in the verification apparatus 1C according to the third preferred embodiment and not described again. However, those which similarly operate but include any slightly different operation are provided with “E” at the end of their reference symbols to be thereby discriminated from the components of the verification apparatus 1C. More specifically, the verification apparatus 1F is characterized in a constitution and a control method of a control device 23F. The constitution and the control method are different to those of the control device 23C of the verification device 1C.

A general control method (verification method) of the verification apparatus 1F is identical to the control method (verification method) of the verification apparatus 1C according to the third preferred embodiment described referring to the flow chart shown in FIG. 5. The description of the general control method (verification method) of the verification apparatus 1F is, therefore, omitted.

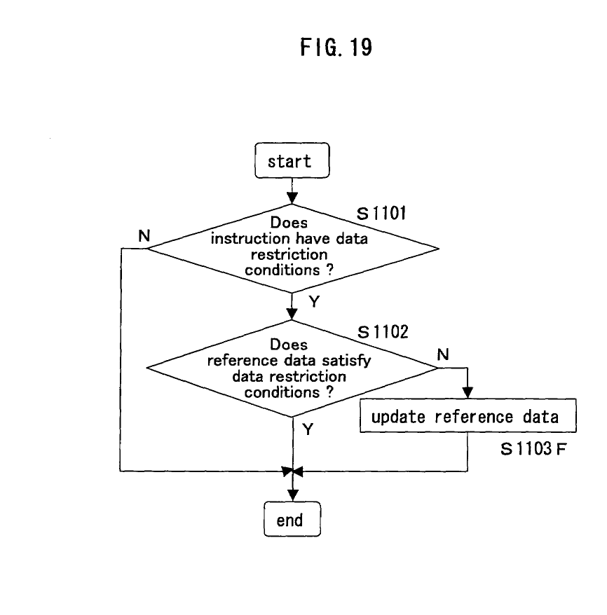

The control device 23F of the verification apparatus 1F according to the present preferred embodiment is characterized in updating the reference data referenced when the instruction is executed when the instruction execution result is judged to be undefined. FIG. 19 shows main steps in the control operation of the verification apparatus 1F. These steps are basically similar to those in the verification apparatus 1C according to the third preferred embodiment 5, and the same steps are provided with the same reference symbols. However, the verification apparatus 1F is different to the verification apparatus 1C as follows.

In the verification apparatus 1C according to the third preferred embodiment, the instruction whose execution result is undefined is replaced with another instruction not having the data restriction condition as shown in the step S1103 of FIG. 11. In the verification apparatus 1F according to the present preferred embodiment, a step 1103F in which the reference data is replaced, as described below, is implemented in place of the foregoing replacement of the instruction.

In step S1103F in which the reference data is updated, the reference data stored in the first and second memory devices 11 and 13 is forcibly updated to the value within the range of the data restriction condition of the relevant instruction. Therefore, even in the case of the instruction whose data to be referenced does not satisfy the data restriction condition, the reference data is updated to the data satisfying the data restriction condition, and the updated reference data is executed by the instruction. Thereby, the generation of the undefined result can be prevented. In order to forcibly update the reference data of the instruction in the verification apparatus 1F, the first memory device (on the side of the simulation device 7) and the second memory device 13 (on the side of the generation value generating device 8) respectively have a function for forcibly updating the recording contents (reference data).

As described, the reference data of the instruction whose execution result is undefined is forcibly updated to the value within the range of the data restriction condition of the relevant instruction in the verification apparatus 1F, which prevents the execution of the instruction whose execution result is undefined. As a result, the discontinuation of the verification due to the pseudo error can be prevented, and the verification can be more efficiently realized.

### Seventh Preferred Embodiment

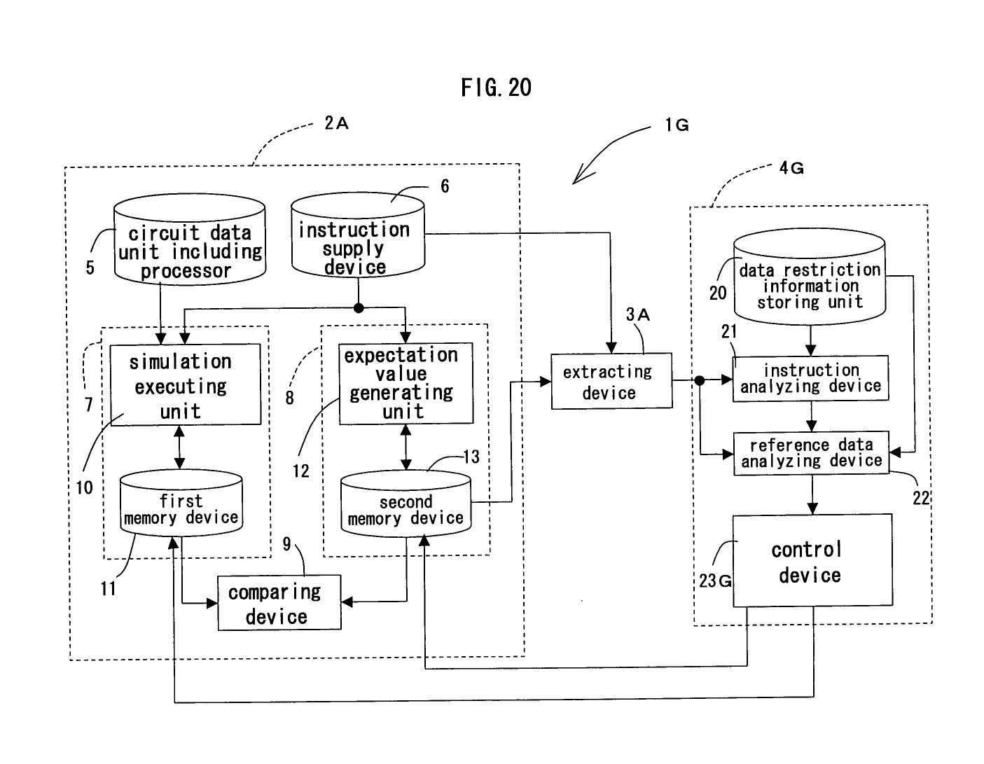

FIG. 20 is a block diagram of a constitution of a verification apparatus 1G according to a seventh preferred embodiment of the present invention. A constitution of the verification apparatus 1G is basically similar to that of the verification apparatus 1C according to the third preferred embodiment. Therefore, any identical or similar part is simply provided with the same reference symbol as in the third preferred embodiment and not described again. However, those which similarly operate but include any slightly different operation are provided with “G” at the end of their reference symbols to be thereby discriminated from the components of the verification apparatus 1C. More specifically, the verification apparatus 1G is characterized in a constitution and a control method of a control device 23G. The constitution and the control method are different to those of the control device 23C of the verification device 1C.

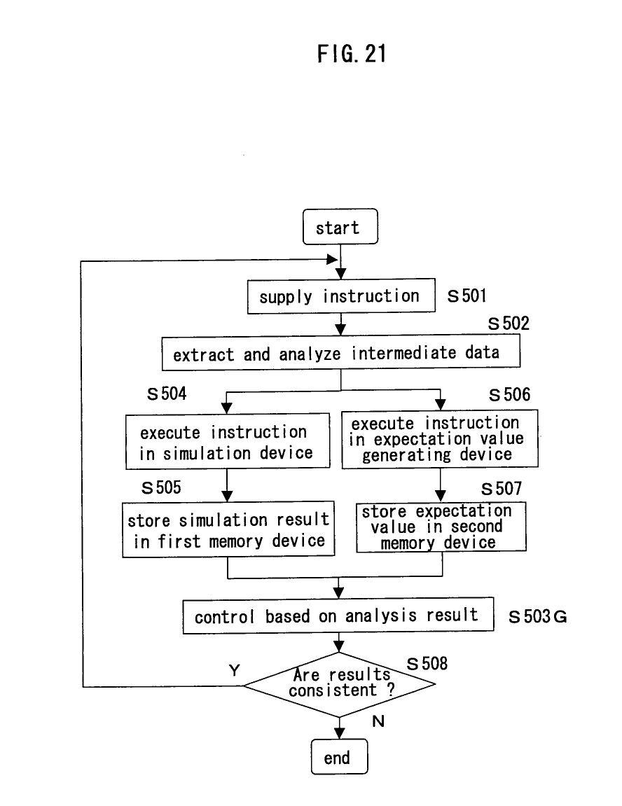

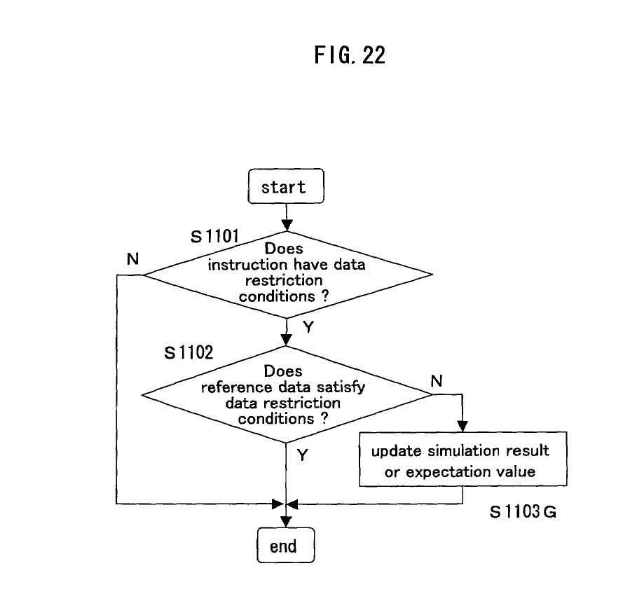

A control method (verification method) in which the verification apparatus 1F is used is described referring to flow charts shown in FIGS. 21 and 22. These flow charts are basically similar to those shown in FIGS. 5 and 11 illustrating the control method (verification method) in the verification apparatus 1C according to the third preferred embodiment, and the same steps are provided with the same reference symbols. The control device 23G of the verification apparatus 1G according to the present preferred embodiment does not replace the instruction whose execution result is undefined with another instruction not having the data restriction condition (step S503 in FIG. 5 and step S1103 in FIG. 11) when the expectation value as the instruction execution result is judged (assumed) to be undefined before the simulation is executed. Instead, the control device 23G forcibly changes the execution result obtained from the actually executed instruction (expectation value and simulation result) to such a value that does not generate the undefined result (step S503G in FIG. 18 and step S1103G in FIG. 19). However, the steps S503G and S1103G are not implemented immediately after the step S502 in which the instruction is extracted but after the instruction is executed in the simulation device 7 and/or the expectation value generating device 8.

More specifically, the control device 23G forcibly updates the instruction execution results stored in the first and second memory devices 11 and 13 (expectation value and simulation result) to the value that can be defined in the instruction. Thereby, even in the case of the instruction whose reference data does not satisfy the data restriction condition, the instruction execution result is updated to the definable data (data judged not to be undefined), which prevents the generation of the undefined result.

As described, the instruction execution result judged to be undefined is forcibly updated to the data judged to be defined in the verification apparatus 1G, so that the execution of the instruction whose execution result is undefined can be prevented. As a result, the discontinuation of the verification due to the pseudo error can be prevented, and the verification can be more efficiently realized.

When the execution result is forcibly updated as described, it is necessary to update the simulation result and the expectation value to an equal value. In order to do so, the simulation result and the expectation value are updated to an appropriate equal value, or one of them can be updated to the value of the other referring to the value of the other.

In order to exert the forcible update function, in the verification apparatus 1G, the first memory device 11 (on the side of the simulation device 7) and the second memory device 13 (on the side of the expectation value generating device 8) respectively have the function for forcibly updating the recording contents (reference data). However, in the case of updating the expectation value to the value of the simulation result referring to the value of the simulation result, the forcible update function may be provided in one of the simulation device 7 and the expectation value generating device 8.

In the verification apparatus 1G according to the present preferred embodiment, the instruction analyzing device 21 and the reference data analyzing device 22 are used to judge the generation of the undefined result, however, the undefined result judging device 32 according to the second preferred embodiment can be used to judge the generation of the undefined result. More specifically, the generation of the undefined result can be judged from the information of the instruction execution result in the expectation value generating device 8 so that the instruction execution result is updated.

### Eighth Preferred Embodiment

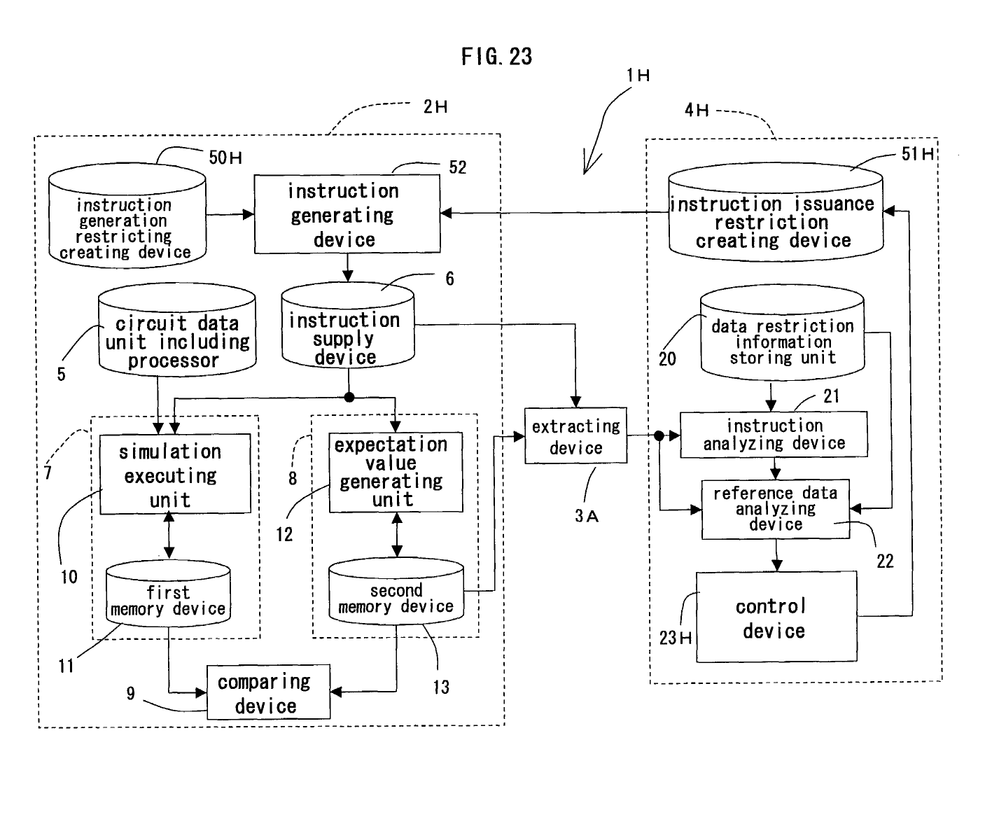

FIG. 23 is a block diagram of a constitution of a verification apparatus 1H according to an eighth preferred embodiment of the present invention. A constitution of the verification apparatus 1H is basically similar to that of the verification apparatus 1C according to the third preferred embodiment. Therefore, any identical or similar part is simply provided with the same reference symbol as in the third preferred embodiment and not described again. However, those which similarly operate but include any slightly different operation are provided with “H” at the end of their reference symbols to be thereby discriminated from the components of the verification apparatus 1C. More specifically, the verification apparatus 1H comprises an instruction generation restriction creating device 50H, an instruction issuance restriction creating device 51H, and an instruction generating device 52H. The instruction generation restriction creating device 50H and the instruction generating device 52H are provided in a main body 2H of the verification apparatus. The instruction issuance restriction creating device 51H is provided in an execution control device 4H. The verification apparatus 1H is characterized in a constitution and a control method (verification apparatus) of a control device 23H.

In the verification apparatus 1H, the instruction is generated by an instruction generating device 52 based on instruction generation restriction generated by the instruction generation restriction creating device 50H and supplied to the instruction supply device 6. The instruction generation restriction includes a type of the generated instruction and condition of the register number that can be selected in the operand. As examples of the instruction generation restriction can be mentioned “the numbers of the general-purpose registers that can be selected in the operand of an addition instruction are register 0 through register 8”, “more than one addition instruction cannot be simultaneously executed in a processor of the VLIW method”, or the like.

The instruction generating device 52 can randomly generate the instruction within the range of the instruction generation restriction. The instruction generating device 52 can further randomly generate all of the instructions to be supplied to the processor, or can mixedly supply the manually generated instructions and the randomly generated instructions to the processor.

A general control method of the verification apparatus 1H (verification method) is identical to the control operation (verification method) of the verification apparatus 1G according to the seventh preferred embodiment described referring to the flow chart shown in FIG. 21. The description of the general control method (verification method) of the verification apparatus 1H is, therefore, is omitted.

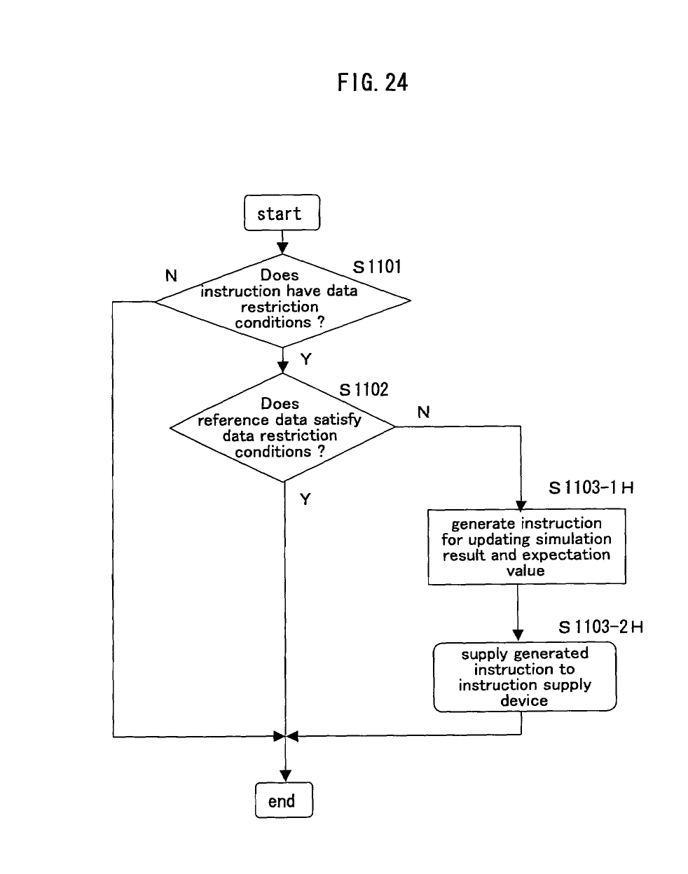

The control device 23H of the verification apparatus 1H according to the present preferred embodiment is characterized in generating an additional instruction which updates the execution result and supplying the generated additional instruction to the instruction supply device 6 when the instruction execution result (simulation result and expectation value) is judged to be undefined. FIG. 24 shows main steps of the control method (verification method) in the verification apparatus 1H. These main steps are basically similar to the those in the verification apparatus 1C according to the third preferred embodiment, and the same steps are provided with the same reference symbols. However, the verification apparatus 1H is different to the verification apparatus 1C as follows.

The control device 23H of the verification apparatus 1H does not replace the instruction not generating the undefined result with another instruction not having the data restriction condition (step S502 in FIG. 5 and step S1103 in FIG. 11) when the instruction execution result (expectation value) is judged to be undefined. Instead, the control device 23H generates an update instruction to be executed after the relevant instruction is executed (step S1103-1H) and supplies the generated update instruction to the instruction supply device 6 so that the update instruction is executed in the simulation device 7 and the expectation value generating device 8 (step S1103-2H).

The update instruction is an instruction for forcibly updating the instruction execution result (simulation result and expectation value) obtained from the simulation device 7 and/or the expectation value generating device 8. The control device 23H makes the instruction generating device 52 issue instruction issuance restriction which indicate the issuance of the update instruction for the undefined execution result when the reference data analyzing device 22 decides that the instruction execution result is undefined. Specific examples of the update instruction include a memory access instruction for reading the execution results from the first and second memory devices 11 and 13 in which the undefined execution results are stored and updating the execution results to an appropriate value, and an instruction for updating the recording data of the first and second memory devices 11 and 12 in which the execution results are stored in accordance with the MOV instruction to an appropriate value.

The instruction generating device 52 is forced to issue the instruction issuance restriction denoting the forcible update of the instruction, and the issued instruction issuance restriction is given to the instruction supply device 6. The instruction supply device 6 generates the update instruction based on the instruction issuance restriction and supplies the generated update instruction to the simulation device 7 and the expectation value generating device 8 to so that the update instruction is executed in these devices 7 and 8. Accordingly, when the instruction whose execution result is undefined is executed, the execution result (undefined) is forcibly updated to the definable data as the additional processing after the instruction referencing the execution result (undefined) is executed. As a result, the pseudo error resulting from the inconsistency between the instruction execution results of the simulation device 7 and the expectation value generating device 8 can be prevented.

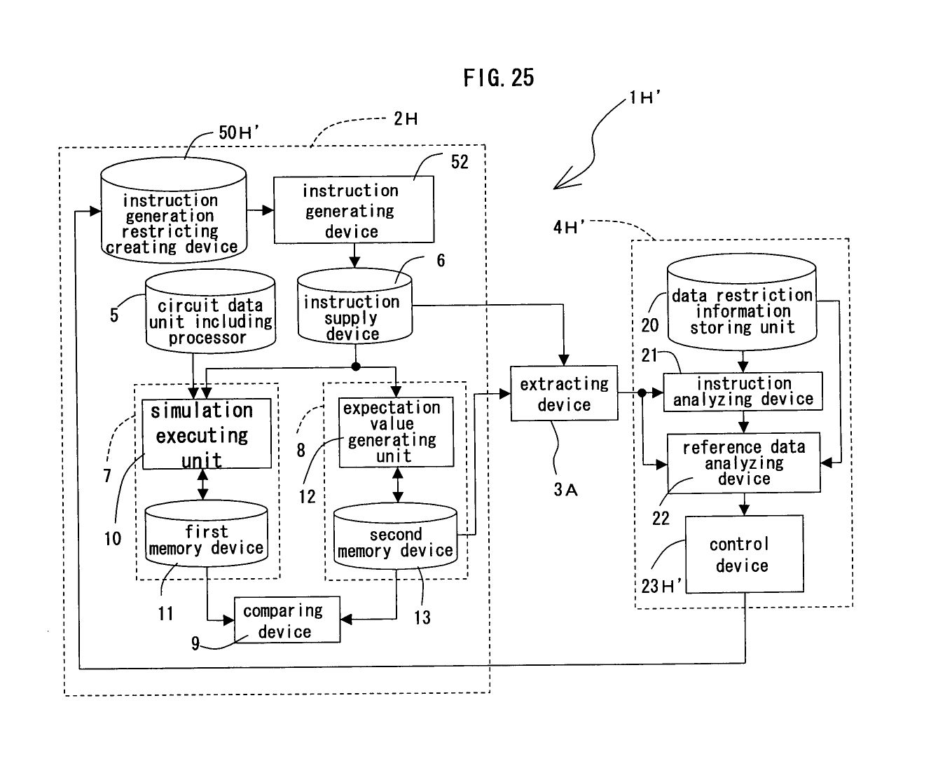

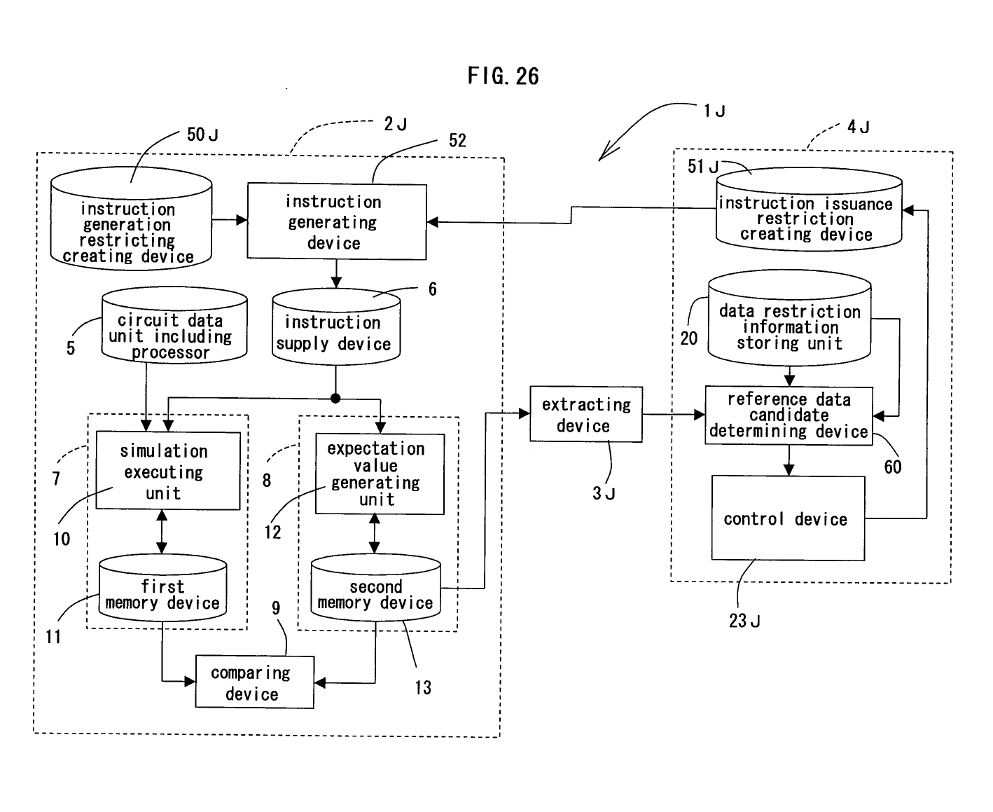

The control method according to the present preferred embodiment can be implemented, not only in the verification apparatus 1H shown in FIG. 23, but also in a verification apparatus 1H′ shown in FIG. 25 in a similar manner. The verification apparatus 1H′ is basically constituted in the same manner as the verification apparatus 1H, and any identical or similar component is provided with the same reference symbol. However, components having any slightly different constitution are provided with (′).

In the verification apparatus 1H, the instruction issuance restriction creating device 51H creates the instruction issuance restriction of the update instruction based on the command by the control device 23H and supplies the created restriction to the instruction generating device 52. In contrast, in the verification apparatus 1H′, the instruction issuance restriction creating device 51H for creating the instruction issuance restriction is not provided. Alternatively, the control device 23H′ forces an instruction generation restriction creating device 50H′ to create the instruction generation restriction as described below and supply the created instruction generation restriction to the instruction generating device 52.

The instruction generation restriction which the control device 23H′ forces the instruction generation restriction creating device 50H′ to create are restriction for forcing the instruction generating device 52 to issue the update instruction of the undefined instruction execution result (simulation result and expectation value). Accordingly, in the verification apparatus 1H′, the instruction generating device 52 issues the update instruction for the undefined result when the undefined result is generated in a manner similar to the verification apparatus 1H.

In the verification apparatuses 1H and 1H′, it is unnecessary to forcibly issue the update instruction for the undefined result immediately after the undefined result is generated. In the case where the instruction generating device 52 randomly generates the instruction, in particular, some regularity is generated in the order in which the instruction is generated if the update instruction is forcibly issued immediately after the undefined result is generated. As a result, the instruction cannot be effectively given in the random order in the verification. Therefore, the instruction for updating the undefined result may be executed before the instruction referencing the undefined result is executed. As a possible method of confirming the execution of the “instruction for referencing the undefined result”, the issuance of the “instruction for referencing the undefined result” is prohibited when the undefined result is generated, and the prohibition of the issuance of the “instruction for referencing the undefined result” is released after the update instruction for the undefined result is issued.

In the present preferred embodiment, the instruction analyzing device 21 and the reference data analyzing device 22 are used to judge the generation of the undefined result, however, the undefined result judging device 32 according to the second preferred embodiment can also be used for the judgment. More specifically, the generation of the undefined result can be decided from the information of the instruction execution result in the expectation value generating unit 12 so that the update instruction is forcibly issued based on a result of the judgment.

### Ninth Preferred Embodiment

FIG. 26 is a block diagram of a constitution of a verification apparatus 1J according to a ninth preferred embodiment of the present invention. A constitution of the verification apparatus 1J is basically similar to that of the verification apparatus 1H according to the eighth preferred embodiment. Therefore, any identical or similar part is simply provided with the same reference symbol as in the eighth preferred embodiment and not described again. However, those which similarly operate but include any slightly different operation are provided with “J” at the end of their reference symbols to be thereby discriminated from the components of the verification apparatus 1H. More specifically, the verification apparatus 1J comprises an instruction generation restriction creating device 50J, an instruction issuance restriction creating device 51J, the instruction generating device 52 and a reference data candidate determining device 60. A control method (verification method) of an extracting device 3J is different to that of the extracting device 3A according to the eighth preferred embodiment. The instruction generation restriction creating device 50J and the instruction generating device 52 are provided in a main body 2J of the verification apparatus. The instruction issuance restriction creating device 51J is provided in an execution control device 4J.

The extracting device 3J extracts the following data value per instruction having the data restriction condition from the second memory device 13. The extracted data value is the register number that selectable as the reference data and the data value stored in the register. The register number that can be selected as the reference data is described below. For example, an DIV instruction has such data restriction condition that a divisor is anything but zero, and the general-purpose register number that can be selected as the divisor when the DIV instruction is executed denotes the register number selectable as the reference data. Assuming that the general-purpose register numbers that can be selected when the instruction is executed based on arbitrary data restriction condition are register 0 through register 31, for example, the extracting device 3J extracts the data values currently stored in the registers 0 through 31. The data information is extracted per instruction having the data restriction condition. In order to thus extract the data information, the extracting device 3J extracts the data information while reading the data restriction condition from the data restriction information storing unit 20.

The execution control device 4J determines the reference data candidate from the data information supplied from the extracting device 3J and the data restriction information supplied from the data restriction information storing unit 20. The reference data candidate refers to the register number that can be referenced by the instruction having the data restriction condition. The reference data candidate is determined per instruction by the reference data candidate determining device 60. The reference data candidate denotes the register in which it is guaranteed that “the candidate value satisfies the data restriction condition of the relevant instruction, and the undefined result is not generated when the instruction is issued with the candidate value as the reference data”. The control device 23J transmits the command for creating the issuance restriction of the instruction whose reference data is the reference data candidate determined by the reference data candidate determining device 60 to the instruction issuance restriction creating device 51J. The instruction issuance restriction creating device 51J creates the instruction issuance restriction based on the command for creating the issuance restriction transmitted by the control device 23J and supplies the created restriction to the instruction generating device 52. The instruction generating device 52 generates the instruction based on the instruction issuance restriction supplied from the instruction issuance restriction creating device 51J and supplies the generated instruction to the instruction supply device 6. The instruction supply device 6 supplies the instruction to the simulation device 7 and the expectation value generating device 8 to be executed therein.

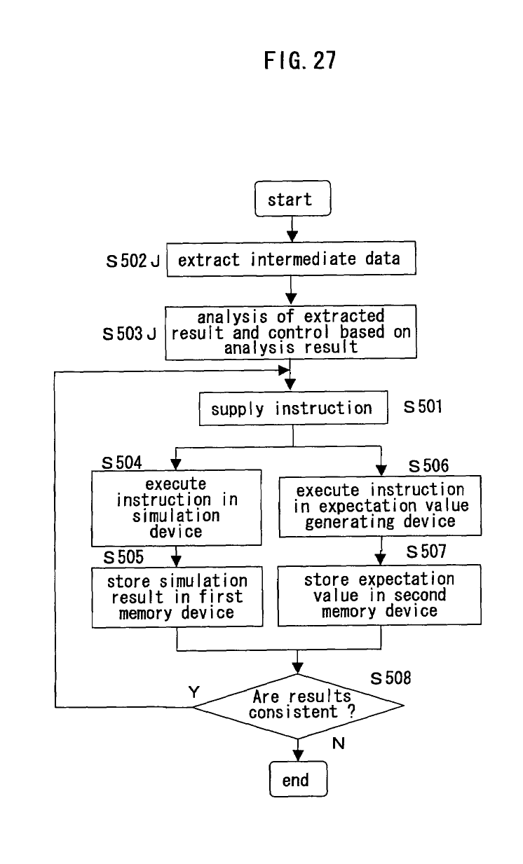

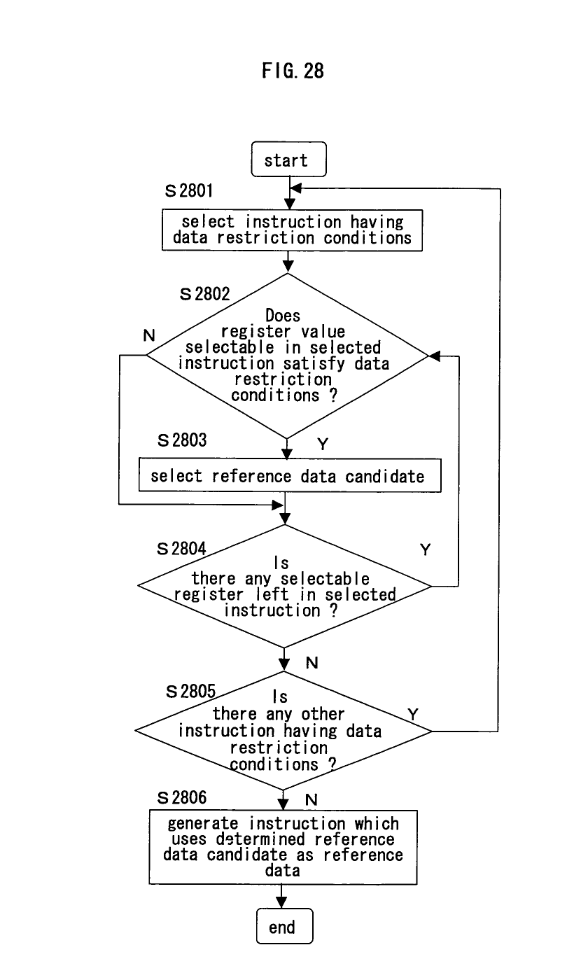

A control method (verification method) in which the verification apparatus 1J is used is described below referring to flow charts shown in FIGS. 27 and 28. The control method in which the verification apparatus 1J is used is basically similar to the operation of the verification apparatus 1C according to the third preferred embodiment (see FIG. 5). Therefore, any step in which the same operation is executed is simply provided with the same step number and not described again. However, in the verification apparatus 1J, the extraction of the intermediate data (S502J), analysis of the extraction result and control based on the analysis result (S503J) are executed prior to the supply of the instruction (S501) timewise. Details of the operations in the steps S502J and S503J are described referring to the flow chart of FIG. 28.

First, an outline of the verification method in which the verification apparatus 1J is used is described. The extracting device 3J extracts the intermediate data of the instruction. The intermediate data is the register number that can be selected as the reference data by the instruction having the data restriction condition and the data value stored in the register as described earlier.

The execution control device 4J creates the instruction issuance restriction to be supplied to the instruction supply device 52 using the intermediate data supplied from the extracting device 3J. The instruction generating device 52 generates the instruction based on the supplied instruction issuance restriction and supplies the generated instruction to the simulation device 7 and the expectation value generating device 8 via the instruction supply device 6. The operations of the simulation device 7, the expectation value generating device 8 and the comparing device 9 are similar to those described in the other embodiments.

Below is described the operation of the execution control device 4J, which is an essential part of the verification method in which the verification apparatus 1J is used. First, the reference data candidate determining device 60 determines the register (reference data candidate) usable in the relevant instruction as the reference data. The reference data candidate is determined with respect to all of the instructions having the data restriction condition. Below are described details of the method of determining the reference data candidate referring to the flow chart of FIG. 28.

The reference data candidate determining device 60 selects one of the instructions having the data restriction condition (S2801). The reference data candidate determining device 60 further analyzes whether or not the data value stored in the register selectable as the reference data satisfies the data restriction condition using the intermediate data supplied from the extracting device 3J (S2802).

When the data value is judged to satisfy the restriction in S2802, the relevant register is determined as the reference data candidate (S2803). The analysis is conducted to all of the registers selectable as the reference data in relation to the instruction (S2804).

When the steps S2802-S2804 are completed in one of the instructions having the data restriction condition, it is judged whether or not there is any other instruction having the data restriction condition (S2805). When the presence of any other instruction is detected in S2805, the steps S2802-S2804 are implemented. Thereby, the reference data candidate (reference data satisfying the data restriction condition) is determined in all of the instructions having the data restriction condition.

After the reference data candidates in all of the instructions are determined, the control device 23J executes the following control operation. The control device 23J executes the instruction referencing the reference data candidate determined by the reference data candidate determining device 60 when the instruction supply device 6 supplies the instruction to the simulation device 7 and the expectation value generating device 8. More specifically describing the control operation, first, the control device 23J commands the instruction issuance restriction creating device 51J to create such instruction issuance restriction that “the instruction is executed with reference to the reference data candidate determined in the reference data candidate determining device 60 when the instruction is executed. The instruction issuance restriction generated by the instruction issuance restriction creating device 51J in response to the command are supplied to the instruction generating device 52. The instruction generating device 52 which received the instruction issuance restriction generates the instruction in accordance with the restriction and supplies the generated instruction to the instruction supply device 6. The instruction supply device 6 supplies the instruction (including the instruction issuance restriction) to the simulation device 7 and the expectation value generating device 8. Thereby, the control operation is realized.

The execution control device 4J of the verification apparatus 1J prepares in advance the reference data candidates satisfying the data restriction condition by observing the value of the register in which the reference data is stored. Then, the reference data is selected from the candidates when the instruction having the data restriction condition is supplied to the simulation device 7 and the expectation value generating device 8 so that the generation of the undefined result is prevented.

In the verification apparatus 1J, it is analyzed whether or not all of the registers that can be selected as the reference data can be the reference data candidate in all of the instructions having the data restriction condition. Therefore, there is generally a plurality of reference data candidates. However, the plurality of reference data candidates is not always necessary, and the processing may shift to the next instruction when one reference data candidate is determined. Thereby, the execution time of the reference data candidate determining device 60 can be reduced. In the case of no reference data candidate, the instruction supply device 6 can be commanded to prohibit the issuance of the relevant instruction.

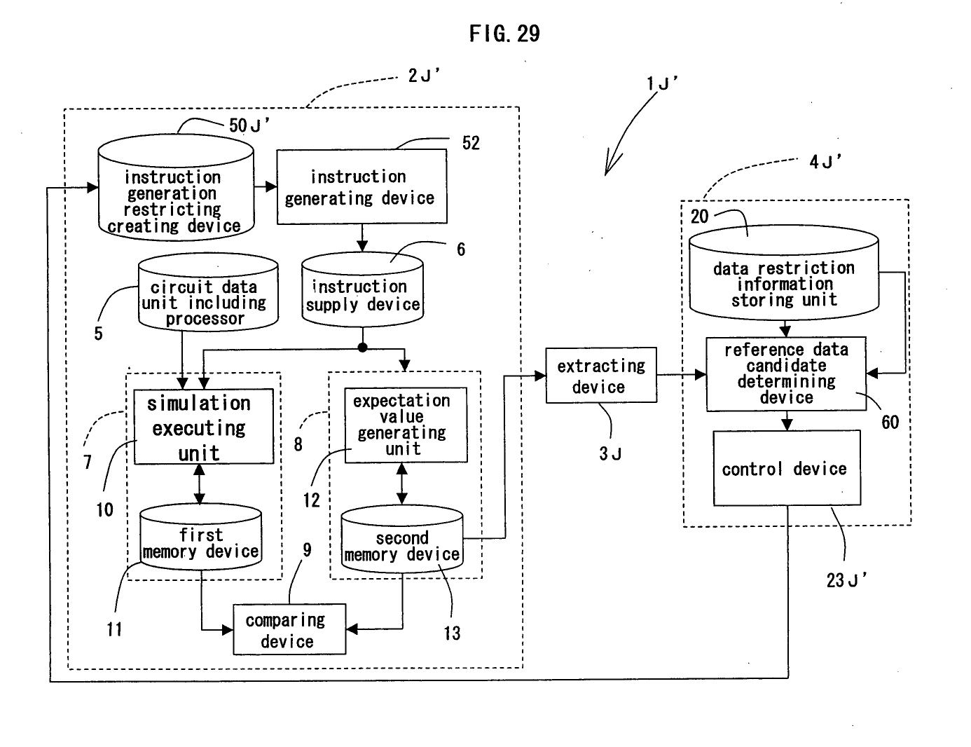

The control method according to the present preferred embodiment may be executed, not only in the verification apparatus 1J shown in FIG. 26, but also in a verification apparatus 1J′ shown in FIG. 29 in a similar manner. The verification apparatus 1J′ is basically constituted in the same manner as the verification apparatus 1J, and any identical or similar component is provided with the same reference symbol. However, any component having any different constitution is provided with (′).

The control device shown in FIG. 26 supplies the determined candidate from the reference data candidate determining device 60 to the instruction generating device 52 as the instruction issuance restriction so that the generation of the undefined result is prevented in the instruction generated by the instruction generating device 52. In contrast, a control device 23J′ shown in FIG. 29 adds the result obtained from the reference data candidate determining device 60 to the existing instruction generation restriction generated by an instruction generation restriction creating device 50J′. The verification apparatus 1J′ thereby prevents the generation of the undefined result in the instruction generated by the instruction generating device 52. Therefore, the instruction issuance restriction creating device 51J is not provided in the verification apparatus 1J′.

As described, the reference data candidate is determined from the register value referenced by the instruction having the data restriction condition in the verification apparatuses 1J and 1J′. Accordingly, the reference data candidate is referenced when the instruction generating device 52 generates the instruction so that the generation of the undefined result can be prevented. The execution of the instruction whose execution result is undefined is thereby prevented. As a result, the discontinuation of the verification due to the pseudo error can be prevented, which improves the efficiency of the verification.

In the verification apparatuses 1A-1J and 1J′ and the verification methods recited in the first through ninth preferred embodiments, the verification object is not limited to the processor, and the apparatuses and methods can be applied to any verification object whose execution result is undefined in accordance with the intermediate data value in the processing executed to the verification object. The test pattern may be the manually described test pattern or randomly generated test pattern. In the respective embodiments, the undefined result caused by the data restriction condition of the reference data was described. However, the factor causing the undefined result may be otherwise as far as the extracting devices 3A, 3B and 3J can extract the information on the factor of the undefined result and register the extracted information in the data restriction information. For example, such a case that the execution result is undefined due to an external factor such as interruption when the instruction is executed can be handled when the undefined result is updated as described in the seventh preferred embodiment.

### INDUSTRIAL APPLICABILITY

A verification apparatus and a verification method according to the present invention can solve such a problem that a pseudo error is generated due to an undefined execution result because a value of a reference data referenced when an instruction is executed fails to satisfy data restriction condition when a simulation result and an expectation value are compared and verified in the case where a test pattern is given to a simulator as a verification object and a simulator for generating the expectation value.

More specifically, interruption of the verification due to the pseudo error is prevented in such a manner that generation of the undefined result is prevented and any influence resulting from the generation of the undefined result is removed in the simulation thereafter. As a result, the foregoing problem can be solved, and the verification can attain a high efficiency. The present invention is particularly effective for verification of a semiconductor integrated circuit on a computing device, or the like.

What is claimed is:

1. A verification apparatus comprising:
a circuit data unit including at least a processor;
a simulation device;
an expectation value generating device;
a comparing device;
an extracting device; and
an execution control device, wherein
the simulation device executes simulation of an instruction executable by the processor in the circuit data unit to thereby generate a simulation result,
the expectation value generating device generates an expectation value when the instruction is executed,
the comparing device compares the simulation result to the expectation value,
the extracting device extracts an information referenced when the expectation value generating device generates the expectation value or the generated expectation value, and
the execution control device judges whether or not the instruction satisfies data restriction condition based on the information extracted by the extracting device, and controls the execution of the instruction in the simulation device and the expectation value generating device based on a result of the judgment.

2. The verification apparatus as claimed in claim 1, wherein
the execution control device observes a value of a register in which the information extracted by the extracting device is stored to thereby judge whether or not the instruction satisfies the data restriction condition.

3. The verification apparatus as claimed in claim 1, wherein
the execution control device halts the execution of the instruction in the simulation device and the expectation value generating device based on the judgment result.

4. The verification apparatus as claimed in claim 3, wherein
the extracting device extracts the instruction executed in the expectation value generating device and a reference data referenced when the instruction is executed, and
the execution control device comprises:
a data restriction information storing unit for storing presence or absence of restriction condition of the reference data referenced when the instruction is executed and contents of the restriction condition;
an instruction analyzing device for analyzing whether or not the instruction has the data restriction condition by collating the instruction and the reference data extracted by the extracting device with the information stored in the data restriction information storing unit;
a reference data analyzing device for analyzing whether or not the reference data of the instruction satisfies the data restriction condition by collating the instruction with the information stored in the data restriction information storing unit when the instruction has the data restriction condition; and
a control device for halting the simulation device and the expectation value generating device when the reference data of the instruction fails to satisfy the data restriction condition.

5. The verification apparatus as claimed in claim 1, wherein
the simulation device comprises an execution standby device for halting the simulation of the simulation device until a halt release notice is received from the execution control device,
the expectation value generating device comprises a prior state shifting device for shifting a state of the expectation value generating device back to a state before the last instruction is executed, and
the execution control device comprises:
an undefined result judging device for judging whether or not the expectation value which is an execution result of the instruction in the expectation value generating device generates an undefined result which cannot be guaranteed as the execution result; and
a control device for making the execution standby device halt the execution of the instruction in the simulation device and making the prior state shifting device shift the state of the expectation value generating device when a result of the judgment shows that the expectation value generates the undefined result.

6. The verification apparatus as claimed in claim 1, wherein
the extracting device extracts the instruction executed in the expectation value generating device and a reference data referenced when the instruction is executed, and
the execution control device comprises:
a data restriction information storing unit for storing presence or absence of restriction condition of the reference data referenced when the instruction is executed and contents of the restriction condition;
an instruction analyzing device for analyzing whether or not the instruction has the data restriction condition by collating the instruction and the reference data extracted by the extracting device with the information stored in the data restriction information storing unit;
a reference data analyzing device for analyzing whether or not the reference data of the instruction satisfies the data restriction condition by collating the instruction with the information stored in the data restriction information storing unit when the instruction has the data restriction condition; and
a control device for replacing the instruction with another instruction not having the data restriction condition when the reference data of the instruction fails to satisfy the data restriction condition and executing the replaced another instruction in the simulation device and the expectation value generating device.

7. The verification apparatus as claimed in claim 1, wherein
the extracting device extracts the instruction executed in the expectation value generating device and a reference data referenced when the instruction is executed, and
the execution control device comprises:
a data restriction information storing unit for storing presence or absence of restriction condition of the reference data referenced when the instruction is executed and contents of the restriction condition;
an instruction analyzing device for analyzing whether or not the instruction has the data restriction condition by collating the instruction and the reference data extracted by the extracting device with the information stored in the data restriction information storing unit;
a reference data analyzing device for analyzing whether or not the reference data of the instruction satisfies the data restriction condition by collating the instruction with the information stored in the data restriction information storing unit when the instruction has the data restriction condition; and
a control device for correcting the instruction into another instruction whose reference data satisfies the data restriction condition when the reference data of the instruction fails to satisfy the data restriction condition and executing the corrected instruction in the simulation device and the expectation value generating device.

8. The verification apparatus as claimed in claim 7, wherein
the control device replaces the reference data of the instruction whose reference data fails to satisfy the data restriction conditions with another reference data satisfying the data restriction condition to thereby execute the replaced another instruction in the simulation device and the expectation value generating device.

9. The verification apparatus as claimed in claim 8, wherein
the control device comprises:
a reference data candidate search device for searching another reference data candidate for the instruction whose reference data is judged not to satisfy the data restriction condition by the reference data analyzing device;
a reference data candidate analyzing device for analyzing whether or not the another reference data candidate searched by the reference data candidate search device satisfies the data restriction condition; and
a reference data replacing device for replacing the reference data with the another reference data candidate when the another reference data candidate satisfies the data restriction condition.

10. The verification apparatus as claimed in claim 7, wherein
the control device generates an update instruction for updating the reference data of the instruction referencing the reference data not satisfying the data restriction conditions, and executes the update instruction in the simulation device and the expectation value generating device prior to the instruction timewise.

11. The verification apparatus as claimed in claim 10, wherein
the control device comprises:
an instruction generating device for generating the update instruction for updating the reference data of the instruction judged to reference the reference data not satisfying the data restriction condition by the reference data analyzing device into another reference data satisfying the data restriction condition.
an instruction placing device for placing the update instruction so that the update instruction can be executed in the simulation device and the expectation value generating device prior to the instruction timewise.

12. The verification apparatus as claimed in claim 1, wherein
the extracting device extracts the instruction executed in the expectation value generating device and a reference data referenced when the instruction is executed, and
the execution control device comprises:
a data restriction information storing unit for storing presence or absence of restriction condition of the reference data referenced when the instruction is executed and contents of the restriction condition;
an instruction analyzing device for analyzing whether or not the instruction has the data restriction condition by collating the instruction and the reference data extracted by the extracting device with the information stored in the data restriction information storing unit;
a reference data analyzing device for analyzing whether or not the reference data of the instruction satisfies the data restriction condition when the instruction has the data restriction condition; and
a control device for forcibly updating the reference data of the instruction so as to satisfy the data restriction condition in the simulation device and the expectation value generating device when the reference data of the instruction fails to satisfy the data restriction condition.

13. The verification apparatus as claimed in claim 1, wherein
the extracting device extracts the instruction executed in the expectation value generating device and a reference data referenced when the instruction is executed, and
the execution control device comprises:
a data restriction information storing unit for storing presence or absence of restriction condition of the reference data referenced when the instruction is executed and contents of the restriction condition;
an instruction analyzing device for analyzing whether or not the instruction has the data restriction condition by collating the instruction and the reference data extracted by the extracting device with the information stored in the data restriction information storing unit;
a reference data analyzing device for analyzing whether or not the reference data of the instruction satisfies the data restriction condition when the instruction has the data restriction condition; and
a control device for updating the simulation result and the expectation value which are obtained as a result of the execution of the instruction in the simulation device and the expectation value generating device so that the simulation result and the expectation value have an equal value when the reference data of the instruction fails to satisfy the data restriction condition.

14. The verification apparatus as claimed in claim 1, wherein
the extracting device extracts the instruction executed in the expectation value generating device and a reference data referenced when the instruction is executed, and
the execution control device comprises:
a data restriction information storing unit for storing presence or absence of restriction condition of the reference data referenced when the instruction is executed and contents of the restriction condition;
an instruction analyzing device for analyzing whether or not the instruction has the data restriction condition by collating the instruction and the reference data extracted by the extracting device with the information stored in the data restriction information storing unit;
a reference data analyzing device for analyzing whether or not the reference data of the instruction satisfies the data restriction condition when the instruction has the data restriction condition; and
a control device for generating an update instruction for updating the simulation result and the expectation value which are obtained as a result of the execution of the instruction in the simulation device and the expectation value generating device and executing the update instruction in the simulation device and the expectation value generating device when the reference data of the instruction fails to satisfy the data restriction condition.

15. A verification method in which a simulation result of an instruction is obtained through simulation of the instruction in a circuit data unit including at least a processor and an expectation value when the instruction is simulated is obtained by means of the instruction so that the circuit data unit is verified based on comparison of the simulation result and the expectation value, comprising:
an extracting step for extracting an information referenced when the expectation value is generated or the generated expectation value;
a judging step for judging whether or not the instruction satisfies data restriction condition based on the information extracted in the extracting step; and
a control step for controlling the simulation of the instruction and the generation of the expectation value of the instruction based on a result of the judgment in the judging step.

16. The verification method as claimed in claim 15, wherein
a value of a register in which the information extracted in the extracting step is stored is observed so that it is judged whether or not the instruction satisfies the data restriction conditions in the control step.

17. The verification method as claimed in claim 15, wherein
the data restriction conditions include conditions which restrict a value range of the reference data.

18. The verification method as claimed in claim 15, wherein
the simulation of the instruction and the generation of the expectation value of the instruction are halted based on the judgment result of the judging step in the control step.

19. The verification method as claimed in claim 18, wherein
the extracting step includes a step of extracting the instruction for generating the expectation value and the reference data referenced when the expectation value of the instruction is generated, and
the control step comprises:
an instruction analyzing step for analyzing whether or not the reference data of the instruction extracted in the extracting step has data restriction condition;
a reference data analyzing step for analyzing whether or not the reference data of the instruction satisfies the data restriction conditions when the instruction has the data restriction condition; and
a control step for halting the simulation of the instruction and the generation of the expectation value of the instruction when the reference data of the instruction fails to satisfy the data restriction condition.

20. The verification method as claimed in claim 19, wherein
the simulation of the instruction and the generation of the expectation value of the instruction are halted until the instruction not having the data restriction condition or the instruction satisfying the data restriction condition is supplied as a next instruction in the control step.

21. The verification method as claimed in claim 15, wherein
the simulation of a next instruction and the generation of the expectation value of the next instruction executed subsequent to the instruction are controlled based on the judgment result of the judging step in the control step.

22. The verification method as claimed in claim 21, wherein
the simulation of the instruction is halted, and the generation of the expectation value of the instruction is shifted back to a state prior to the generation based on the judgment result of the judging step in the control step.

23. The verification method as claimed in claim 22, wherein
the expectation value obtained through the generation of the expectation value of the instruction is extracted in the extracting step, and
the control step comprises:
an undefined result judging step for judging whether or not the expectation value obtained through the generation of the expectation value of the instruction generates an undefined result which cannot be guaranteed as an execution result of the instruction; and
a prior state shifting step for halting the simulation of the instruction and shifting the generation of the expectation value of the instruction back to the state prior the generation when a result of the judgment shows that the expectation value generates the undefined result.

24. The verification method as claimed in claim 15, wherein
the extracting step includes a step of extracting an instruction executed in the expectation value generation and a reference data referenced when the instruction is executed, and
the control step comprises:
an instruction analyzing step for analyzing whether or not the instruction has the data restriction condition by collating the instruction and the reference data extracted in the extracting step with restriction conditions of the reference data referenced when the instruction is executed;
a reference data analyzing step for analyzing whether or not the reference data of the instruction satisfies the data restriction condition by collating the reference data of the instruction with the restriction conditions of the reference data referenced when the instruction is executed when the instruction has the data restriction condition; and
a control step for replacing the instruction with another instruction not having the data restriction conditions when the reference data of the instruction fails to satisfy the data restriction conditions, simulating the replaced another instruction and generating the expectation value of the replaced another instruction.

25. The verification method as claimed in claim 15, wherein
the extracting step includes a step of extracting an instruction executed in the generation of the expectation value and a reference data referenced when the instruction is executed, and
the control step comprises:
an instruction analyzing step for analyzing whether or not the instruction has the data restriction condition by collating the instruction and the reference data extracted in the extracting step with restriction conditions of the reference data referenced when the instruction is executed;
a reference data analyzing step for analyzing whether or not the reference data of the instruction satisfies the data restriction condition when the instruction has the data restriction condition; and
a control step for correcting the instruction into another instruction whose reference data satisfies the data restriction condition, simulating the corrected instruction and generating the expectation value of the corrected instruction when the reference data of the instruction fails to satisfy the data restriction condition.

26. The verification method as claimed in claim 25, wherein
the reference data of the instruction is replaced with another reference data satisfying the data restriction condition when the reference data of the instruction fails to satisfy the data restriction condition in the control step.

27. The verification method as claimed in claim 26, wherein
the control step comprises:
a candidate search processing for searching another reference data candidate for the instruction analyzed to have the reference data not satisfying the data restriction condition in the reference data analyzing step;
a candidate analyzing processing for analyzing whether or not the another reference data candidate searched in the candidate search processing satisfies the data restriction condition; and
a reference data replacing processing for replacing the reference data with the another reference data candidate satisfying the data restriction condition.

28. The verification method as claimed in claim 25, wherein
an update instruction for updating the reference data of the instruction into another reference data satisfying the data restriction condition is generated when the reference data of the instruction fails to satisfy the data restriction condition, the reference data is updated based on the update instruction, and the instruction is simulated and the expectation value of the instruction is generated in the control step.

29. The verification method as claimed in claim 28, wherein
the control step comprises:
an update instruction generating processing for generating the update instruction for updating the reference data of the instruction into the another reference data satisfying the data restriction conditions when the reference data of the instruction fails to satisfy the data restriction conditions; and
an instruction placing processing for placing the update instruction so that the update instruction is executed before the simulation of the instruction and the generation of the expectation value of the instruction.

30. The verification method as claimed in claim 15, wherein
the reference data is updated into data satisfying the data restriction conditions when it is judged in the judging step that the reference data fails to satisfy the data restriction conditions in the control step.

31. The verification method as claimed in claim 30, wherein
the extracting step includes a step of extracting an instruction executed in the generation of the expectation value and a reference data referenced when the instruction is executed, and
the control step comprises:
an instruction analyzing step for analyzing whether or not the instruction has the data restriction condition by collating the instruction and the reference data extracted in the extracting step with restriction conditions of the reference data referenced when the instruction is executed;
a reference data analyzing step for analyzing whether or not the reference data of the instruction satisfies the data restriction condition when the instruction has the data restriction condition; and
a control step for forcibly updating the reference data into another reference data satisfying the data restriction condition, simulating the instruction and generating the expectation value of the instruction when the reference data of the instruction fails to satisfy the data restriction condition.

32. The verification method as claimed in claim 24, wherein
the simulation result and the expectation value obtained through the simulation of the instruction and the generation of the expectation value of the instruction are updated to have an equal value when it is judged in the judging step that the reference data fails to satisfy the data restriction conditions in the control step.

33. The verification method as claimed in claim 32, wherein the extracting step includes a step of extracting an instruction executed in the generation of the expectation value and a reference data referenced when the instruction is executed, and
the control step comprises:
an instruction analyzing step for analyzing whether or not the instruction has the data restriction condition by collating the instruction and the reference data extracted in the extracting step with restriction conditions of the reference data referenced when the instruction is executed;
a reference data analyzing step for analyzing whether or not the reference data of the instruction satisfies the data restriction condition when the instruction has the data restriction condition; and
a control step for updating the simulation result and the expectation value obtained through the simulation of the instruction and the generation of the expectation value of the instruction so as to have an equal value when the reference data of the instruction fails to satisfy the data restriction condition.

34. The verification method as claimed in claim 32, wherein
the simulation result is updated to have a value equal to the expectation value, or the expectation value is updated to have a value equal to the simulation result in the control step.

35. The verification method as claimed in claim 15, wherein
the extracting step includes a step of extracting an instruction executed in the generation of the expectation value and a reference data referenced when the instruction is executed, and
the control step comprises:
an instruction analyzing step for analyzing whether or not the instruction has the data restriction condition by collating the instruction and the reference data extracted in the extracting step with restriction conditions of the reference data referenced when the instruction is executed;
a reference data analyzing step for analyzing whether or not the reference data of the instruction satisfies the data restriction condition when the instruction has the data restriction condition; and
a control step for generating an update instruction for updating the simulation result and the expectation value obtained through the simulation of the instruction and the generation of the expectation value of the instruction and executing the update instruction after the simulation of the instruction and the generation of the expectation value of the instruction when the reference data of the instruction fails to satisfy the data restriction condition.
